(19) United States
(12) Patent Application Publication
(10) Pub. No.: US 2024/0287288 A1
(43) Pub. Date: Aug. 29, 2024

(54) SYSTEMS AND METHODS FOR DISCOVERY OF POLYMER COMPOSITES FORMED OF NATURAL MATERIALS

(71) Applicant: UNIVERSITY OF MARYLAND, COLLEGE PARK, College Park, MD (US)

(72) Inventors: Po-Yen CHEN, Bethesda, MD (US); Tianle CHEN, Hyattsville, MD (US); Liangbing HU, Rockville, MD (US)

(21) Appl. No.: 18/590,397

(22) Filed: Feb. 28, 2024

Related U.S. Application Data
(60) Provisional application No. 63/487,489, filed on Feb. 28, 2023.

(51) Int. Cl. C08L 5/00; G06N 3/02

(52) U.S. Cl. CPC C08L 5/00; G06N 3/02

(57) ABSTRACT

A system for discovery of polymer composites can include one or more robotic systems and a machine learning system. The robotic system(s) can fabricate polymer composites, each comprising a mixture of at least two natural materials. The machine learning system can include a screening module, an input/output module, a data augmentation module, a training module, and a prediction module. The screening module can select a reduced design space for polymer composite mixture recipes. The input/output module can instruct the robotic system(s) to fabricate polymer composites and receive measurements of physical characteristics of the fabricated polymer composites to form a data set. The data augmentation module can augment the data set with virtual data points. The training module can train an artificial neural network (ANN) based on the augmented data set. The prediction module can predict a mixture recipe or physical characteristics for a desired polymer composite using the trained ANN.

### CROSS-REFERENCE TO RELATED APPLICATIONS

The present application claims the benefit of U.S. Provisional Application No. 63/487,489, filed Feb. 28, 2023 and entitled “Devices, Systems, and Methods for Machine Intelligence-Accelerated Discovery of All-Natural Plastic Substitutes,” which is hereby incorporated by reference herein in its entirety.

### FIELD

The present disclosure relates generally to polymer composites, and more particularly, to polymer composites formed of natural materials, for example, biodegradable polymers, and systems and methods for discovery and fabrication thereof.

### BACKGROUND

While petrochemical plastics are extensively used due to their favorable properties, less than 10% of petrochemical plastics can be recycled. Instead, nearly 80% of used plastics end up in landfills or otherwise pollute the environment. To reduce the use of petrochemical plastics, substitutes are being developed using natural components that breakdown (e.g., biodegrade), thereby reducing the amount of pollution from petrochemical plastic. However, discovering biodegradable alternatives that meet specific property criteria presents significant challenges. Current approaches rely on trial-and-error experiments and probe a broad range of parameters in a scattershot manner. As more plastics are targeted for replacement, the time and cost required to find suitable biodegradable substitutes using conventional methods will increase accordingly. Embodiments of the disclosed subject matter may address one or more of the above-noted problems and disadvantages, among other things.

### SUMMARY

Embodiments of the disclosed subject matter provide systems and methods for discovery of polymer composites formed of natural materials. In contrast to conventional approaches that rely on iterative optimization experiments, embodiments of the disclosed subject matter can employ robotics (e.g., automated pipetting robot) and machine learning to accelerate the discovery of all-natural (e.g., formed completely or mostly of natural materials) plastic substitutes exhibiting multiple desired properties (e.g., programmable optical, thermal, and mechanical properties). In some embodiments, the robotics can prepare multiple candidate composites having different mixture recipes, and the candidate composites can be classified (e.g., graded) to train a classifier (e.g., support-vector machine classifier), for example, to reduce the design space (e.g., based on composite viability, water solubility, or any other desired property). In some embodiments, through active learning loops with data augmentation, training composites can be fabricated stagewise with recipes in the reduced design space and used to train an artificial neural network (ANN) prediction model. The trained ANN prediction model can then be used to conduct desired design tasks, such as predicting the physiochemical properties of a target composite based on its composition and/or automating the inverse design of a composite that fulfills a specified application requirement.

In one or more embodiments, a method can comprise fabricating a plurality of candidate polymer composites via one or more robotic systems. Each candidate polymer composite can comprise a mixture of at least two natural materials. Each natural material can be a naturally-occurring polysaccharide, a naturally-occurring protein, a naturally-occurring mineral, or a naturally-occurring alcohol. The method can further comprise grading each of the candidate polymer composites in the fabricated plurality with respect to one or more predetermined criteria, training a classifier based at least in part on the grading, and selecting a reduced design space for mixture recipes of subsequent training polymer composites using the trained classifier.

In some embodiments, the method can also comprise determining mixture recipes within the reduced design space for a plurality of training polymer composites. Each training polymer composite can comprise a mixture of the at least two natural materials. The method can further comprise fabricating the plurality of training polymer composites according to the determined mixture recipes via the one or more robotic systems. The method can also comprise generating a data set based on measurements of one or more physical characteristics of the plurality of training polymer composites. Each measurement can comprise an actual data point within the data set. The method can further comprise augmenting the data set with a plurality of virtual data points. The method can also comprise training one or more artificial neural networks based at least in part on the augmented data set and predicting a mixture recipe or one or more physical characteristics for a desired polymer composite using the one or more artificial neural networks.

In some embodiments, the method can further comprise determining mixture recipes within the reduced design space for a different plurality of training polymer composites using the one or more artificial neural networks, and repeating at least once the fabricating the different plurality, generating a data set, augmenting the data set, and the training of the one or more artificial neural networks.

In one or more embodiments, a system can comprise one or more robotic systems and a machine learning system. The one or more robotic systems can be constructed to fabricate polymer composites. Each polymer composite can comprise a mixture of at least two natural materials. Each natural material can be a naturally-occurring polysaccharide, a naturally-occurring protein, a naturally-occurring mineral, or a naturally-occurring alcohol. The machine learning system can be in communication with the one or more robotic systems. The machine learning system can comprise one or more processors and one or more non-transitory computer-readable storage media storing computer-readable instructions that, when executed by the one or more processors, cause the one or more processors to perform functions of one or more constituent modules.

In some embodiments, the machine learning system can comprise a screening module, an input/output module, a data augmentation module, a training module, and a prediction module. The screening module can be configured to train a classifier based at least in part on grading of candidate polymer composites with respect to one or more predetermined criteria. The screening module can also be configured to select a reduced design space for mixture recipes of subsequent training polymer composites using the trained classifier. The input/output module can be configured to instruct the one or more robotic systems to fabricate training polymer composites according to respective mixture recipes within the reduced design space. The input/output module can also be configured to receive measurements of one or more physical characteristics of fabricated polymer composites. Each measurement can form an actual data point in a data set.

The data augmentation module can be configured to augment the data set with a plurality of virtual data points. The training module can be configured to train one or more artificial neural networks of the machine learning system based at least in part on the augmented data set. The training module can also be configured to determine the respective mixture recipes within the reduced design space for the training polymer composites to be fabricated by the one or more robotic systems using the one or more artificial neural networks. The prediction module can be configured to predict a mixture recipe or one or more physical characteristics for a desired polymer composite using the one or more artificial neural networks.

In one or more embodiments, a non-transitory computer-readable storage medium can store computer-readable instructions that, when executed by one or more processors, cause the one or more processors to determine mixture recipes for a plurality of polymer composites. Each polymer composite can comprise a different mixture of at least two natural materials, and each natural material can be a naturally-occurring polysaccharide, a naturally-occurring protein, a naturally-occurring mineral, or a naturally-occurring alcohol. The stored computer-readable instructions can further cause the one or more processors to instruct fabrication of the plurality of polymer composites according to the determined mixture recipes. The stored computer-readable instructions can also cause the one or more processors to receive a data set comprising measurements of one or more physical characteristics of the plurality of polymer composites, each measurement comprising an actual data point within the data set. The stored computer-readable instructions can further cause the one or more processors to augment the data set with a plurality of virtual data points, and train one or more artificial neural networks based at least in part on the augmented data set. The stored computer-readable instructions can also cause the one or more processors to predict a mixture recipe or one or more physical characteristics for a desired polymer composite using the one or more artificial neural networks.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of discovery of polymer composites formed of natural materials, according to one or more embodiments of the disclosed subject matter.

FIGS. 1B-1C are simplified schematic diagrams illustrating aspects of systems for discovery of polymer composites formed of natural materials, according to one or more embodiments of the disclosed subject matter.

FIG. 2 is a process flow diagram for a method for discovery of polymer composites formed of natural materials, according to one or more embodiments of the disclosed subject matter.

FIG. 3 depicts a generalized example of a computing environment in which the disclosed technologies may be implemented.

FIG. 4A illustrates discrete grades assigned for 286 nanocomposite films fabricated with different amounts of montmorillonite (MMT) nanosheets, cellulose nanofibers (CNF), gelatin, and glycerol, as well as photos of nanocomposite films with four different grades in the bottom inset.

FIG. 4B is a three-dimensional heatmap representing the possibility (%) of obtaining an A-grade nanocomposite film at different MMT/CNF/gelatin/glycerol ratios.

FIG. 4C illustrates aspects of an artificial-neural-network-based (ANN-based) prediction model via active learning loops and in silico data augmentation.

FIG. 4D is a three-dimensional diagram of Voronoi tessellation after 14 active learning loops.

FIG. 4E is a graph of mean relative error (MRE) values of different prediction models based on linear regression, decision tree, gradient-boosted decision tree, random forest, and ANN algorithms.

FIG. 4F is a graph of MRE values and training time (dashed lines) of different prediction models based on various virtual-to-real data ratios.

FIGS. 5A-5C are graphs of transmittance spectra, residual ratio (RR), and stress-strain curves, respectively, for nanocomposites fabricated with different MMT/CNF/gelatin/glycerol ratios.

FIGS. 6A-6C are graphs of transmittance spectra, RR, and stress-strain curves, respectively, for nanocomposites fabricated with similar MMT/CNF/gelatin/glycerol ratios.

FIG. 6D is a graph illustrating measurement variations of transmittance, RR, and mechanical properties of nanocomposites fabricated with the same MMT/CNF/gelatin/glycerol ratios.

FIG. 7 is a graph of normalized average cell volumes of three-dimensional Voronoi diagrams, and their variances, at different active learning stages.

FIG. 8A is a graph comparing measured optical transmittance spectra and model-predicted spectral labels of three fabricated nanocomposites.

FIG. 8B is a graph comparing measured RR values and model-predicted fire labels of three fabricated nanocomposites.

FIG. 8C is a graph comparing measured stress-strain curves and model-predicted stress-strain curves of five fabricated nanocomposites.

FIGS. 8D-8F are three-dimensional heatmaps representing the spatial distribution within the feasible design space of model-predicted labels of T_{Vis}, RR, and σᵤ, respectively.

FIG. 8G is a graph of MRE values of the champion ANN model during a model expansion process incorporating chitosan into the design space.

FIG. 8H shows violin plots of Tᵥᵢₛ, σᵤ, ε_{f}, and E labels with and without chitosan incorporation.

FIGS. 9A-9D are three-dimensional heatmaps representing the spatial distribution within the feasible design space of model-predicted labels of T_{UV}, T_{IR}, ε_{f}, and E, respectively.

FIG. 10 is a three-dimensional heatmap representing the spatial distribution within the feasible design space of model-predicted thickness labels.

FIG. 11 shows violin plots of T_{UV}, T_{IR}, and RR labels.

FIG. 12A is a three-dimensional heatmap showing identified cluster centers for nanocomposites with high σᵤ.

FIG. 12B is a three-dimensional heatmap showing fabricated nanocomposites within the identified cluster centers of FIG. 12A, the recipes for which nanocomposites were suggested by the model.

FIG. 12C is a graph comparing σᵤ labels of model-suggested nanocomposites near the MMT-rich cluster in FIG. 12A, where the orange bar represents a fabricated nanocomposite with a recipe at the MMT-rich cluster center and the blue bars represent fabricated nanocomposites with recipes near the MMT-rich cluster center.

FIG. 12D is a graph comparing σᵤ labels of model-suggested nanocomposites near the CNF-rich cluster in FIG. 12A, where the orange bar represents a fabricated nanocomposite with a recipe at the CNF-rich cluster center and the blue bars represent fabricated nanocomposites with recipes near the CNF-rich cluster center.

FIG. 13A is a graph of ultimate strength (σᵤ) versus Young's modulus (E) for various conventional polymers (engineering polymers) and model-predicted all-natural nanocomposites.

FIG. 13B is a graph of σᵤ versus E of >200 all-natural nanocomposites fabricated during active learning loops, model expansion, and after two-step treatments, where points in green represent prior developed plastic substitutes and the dot color represents the T_{Vis} label of each nanocomposite.

FIG. 13C are images illustrating the biodegradability of commercially-available plastic films (polyethylene and polystyrene) versus fabricated nanocomposites (the MMT/CNF/gelatin/glycerol ratios of #1 and #2 being 60.0/3.0/24.0/13.0 and 6.0/36.0/1.0/57.0, respectively) buried in soil for 5 weeks.

FIG. 13D show the normalized Shapley Additive exPLanations (SHAP) values of MMT, CNF, gelatin, and glycerol loadings on T_{Vis}, RR, and σᵤ.

FIG. 14 is a graph of σᵤ versus E of >150 all-natural nanocomposites fabricated during active learning loops, model expansion, and after two-step treatments, where the dot color represents the RR label of each nanocomposite.

FIGS. 15A-15C are graphs of Spearman's rank correlation coefficients (Spearman's p) of MMT, CNF, gelatin, and glycerol loadings on spectral labels (T_{UV}, T_{Vis}, and T_{IR}), fire resistance label (RR), and mechanical labels (ε_{f}, σᵤ, and E), respectively.

FIG. 16A illustrates plotting to get a global interpretation of the prediction model by using the SHAP values of every feature for every data point.

FIG. 16B shows the SHAP values of MMT, CNF, gelatin, and glycerol loadings on T_{UV}, T_{IR}, ε_{f}, and E.

FIGS. 17A-17C show atomic structures for molecular dynamics (MD) simulations for CNF only, MMT only, and MMT/CNF models, respectively, before and after tensile failure, with the insets showing scanning electron microscopy (SEM) images of the fracture surfaces of respective thin films.

FIG. 17D shows simulated stress-strain curves for CNF only, MMT only, and MMT/CNF models.

FIG. 17E compares ultimate strengths and Young's moduli extracted from MD-simulated and experimental results.

FIG. 17F shows normalized SHAP values of MMT loading, CNF loading, gelatin loading, glycerol loading, gelatin source, and MMT size on T_{Vis}, RR, and σᵤ.

FIG. 18 shows normalized SHAP values of MMT loading, CNF loading, gelatin loading, glycerol loading, gelatin source, and MMT size on T_{UV}, T_{IR}, ε_{f}, and E.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Polymer Composite: A mixture of at least two materials, at least one of which is a polymer. In some embodiments, one, some, or all of the materials in the mixture are natural materials. In some embodiments, one, some, or all of the materials in the mixture have a minimum cross-sectional dimension less than 1 μm (e.g., in the nanometer regime), and the polymer composite can be considered a nanocomposite.

Natural material: A naturally-occurring (e.g., not man-made) material, for example, a naturally-occurring polysaccharide, a naturally-occurring protein, a naturally-occurring mineral, or a naturally-occurring alcohol. In some embodiments, the natural material can be produced by or derived from a living organism, such as a plant, fungus, insect, crustacean, animal, etc. In some embodiments, the natural material is a generally recognized as safe (GRAS) material, for example, as listed in the Select Committee on GRAS Substances (SCOGS) database maintained by the Food and Drug Administration (FDA). In some embodiments, the naturally-occurring polysaccharides can include, but are not limited to, cellulose and its derivatives (cellulose nanofibers (CNF), such as nanofibrillated cellulose (NFC); microfibrillated cellulose; carboxymethyl cellulose; etc.), chitin and its derivatives (e.g., chitosan), starch and its derivatives, glycogen, agar, alginate, pectin, xanthan, guar gum, carrageenan, hyaluronic acid, and gum arabic. In some embodiments, the naturally-occurring proteins can include, but are not limited to, gelatin. In some embodiments, the naturally-occurring minerals can include, but are not limited to, montmorillonite (MMT) (e.g., MMT nanosheets). In some embodiments, the naturally-occurring alcohols can include, but are not limited to, a polyalcohol or sugar alcohol, such as glycerol.

Biodegradable material: A material that degrades under aerobic conditions in soil, for example, as measured by ISO Standards 14855-1:2012, published December 2012 and entitled “Determination of the ultimate aerobic biodegradability of plastic materials under controlled composting conditions, Method by analysis of evolved carbon dioxide, Part 1: General method,” and 14855-2:2018, published July 2018 and entitled “Determination of the ultimate aerobic biodegradability of plastic materials under controlled composting conditions, Method by analysis of evolved carbon dioxide, Part 2: Gravimetric measurement of carbon dioxide evolved in a laboratory-scale test,” which ISO Standards are incorporated by reference herein.

### INTRODUCTION

Disclosed herein are systems and methods for discovery of polymer composites (e.g., nanocomposites) formed of natural materials, for example, to meet specific application requirements (e.g., material properties such as optical transparency, fire retardancy, mechanical properties, etc.). A polymer composite can be formed by mixing multiple natural building block units. However, conventional simulation tools are not efficient enough to describe such complex systems, nor do they allow for optimization of multiple properties simultaneously (e.g., high transparency, fire retardancy, and tensile strength). In contrast, embodiments of the disclosed subject matter offer a prediction model (e.g., by employing machine learning) that can optimize multiple physicochemical properties of a polymer composite and automatically suggest fabrication parameters without the need for trial-and-error experiments.

Machine learning (ML), which is a form of artificial intelligence (AI) that constructs a model to make predictions or recommendations, has been effective in revealing complex correlations across multiple degrees of freedom (DOFs). For example, AI/ML has particularly benefited the fields of organic/inorganic catalyst design, drug discovery, and quantum dot synthesis, in which simulation tools or high-throughput analytical platforms are available to supply a large number of data points for high-accuracy model training. However, substantial obstacles exist in obtaining a high-accuracy prediction model for polymer composites since the acquisition of high-quality data points can be both time-consuming and labor-intensive. As such, existing techniques for discovering composites that can substitute for existing plastics focus on optimizing a single characteristic (e.g., optical transparency or mechanical strength). Embodiments of the disclosed subject matter provide an integrated workflow that uses robotics and AI/ML predictions, which can accelerate the discovery of polymer composites with multiple desired properties (e.g., programmable optical, thermal, and mechanical properties). In some embodiments, the polymer composites can be formed entirely (or at least mostly) of natural materials (e.g., generally recognized as safe natural components), for example, for use as an all-natural biodegradable plastic substitute. Alternatively or additionally, polymer composites can be designed for use in wide range of fields, for example, tactile sensors, stretchable conductors, electrochemical electrolyte optimization, and thermal insulative aerogels.

In some embodiments, one or more robotic systems can be used to prepare candidate composites with different recipes (e.g., different building block ratios, such as cellulose nanofibers (CNF), montmorillonite (MMT) nanosheets, chitosan, gelatin, and/or glycerol). The quality of the resulting composites can then be evaluated (e.g., graded) and used to a train a classifier (e.g., a support-vector machine (SVM) classifier), for example, to limit or reduce a design space. Using active learning loops with data augmentation, training composites with different recipes in the reduced design space can be stagewise fabricated and used to train one or more artificial neural network (ANN) models. Using the trained ANN model, multiple characteristics of a polymer composite can be predicted based solely on its composition (e.g., mixture recipe). Alternatively or additionally, the ANN model can automatically suggest suitable compositions for a polymer composite based on desired properties for a particular application (e.g., user-designated features).

### Polymer Composite Discovery Systems

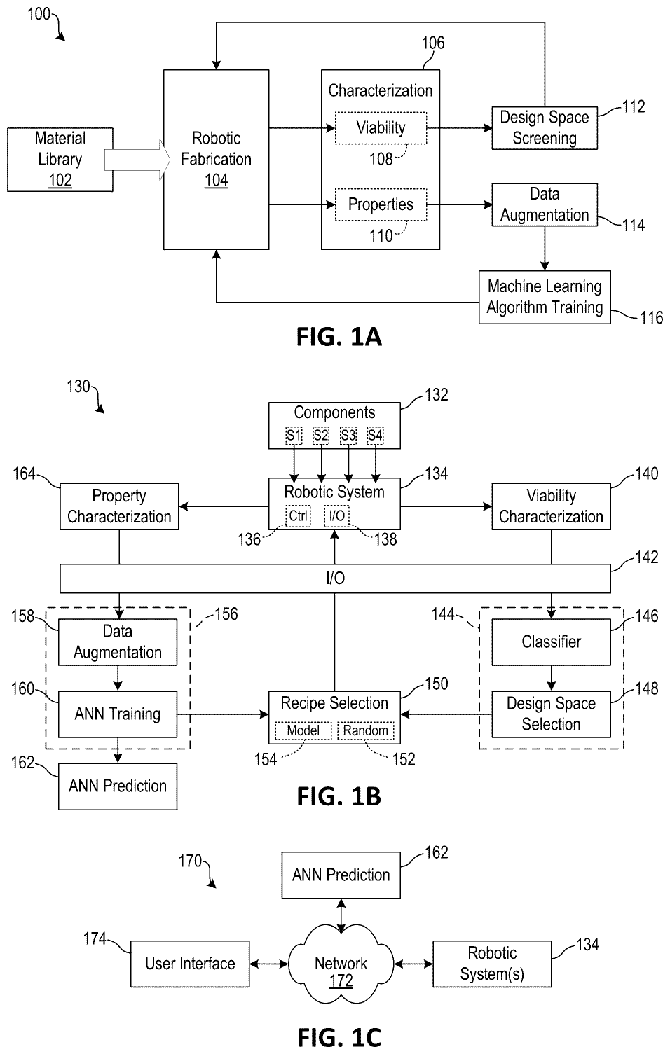

As shown in FIG. 1A, a polymer composite discovery system 100 can include a material library 102, a robotic fabrication system 104, a characterization system 106, a design space screening module 112, a data augmentation module 114, and a machine learning algorithm training module 116. In some embodiments, the material library 102 can include constituent natural materials (e.g., generally recognized as safe materials) for subsequent mixing to form polymer composites. In some embodiments, some or all of the natural materials in the material library 102 can be in respective solutions (e.g., water). The robotic fabrication system 104 can include one or more components for mixing the natural materials from the material library 102 and forming the polymer composites. For example, the robotic fabrication system 104 can include a pipetting robot. Alternatively or additionally, the robotic fabrication system 104 can include other fabrication tools, such as but not limited to drying means (e.g., oven).

In the illustrated example, the characterization system 106 includes a viability characterization module 108 and a properties characterization module 110. In some embodiments, the viability characterization module 108 can include means for evaluating fabricated polymer composites with respect to one or more predetermined criteria. For example, the predetermined criteria can be related to viability of the fabricated polymer composite for use in a particular application. In some embodiments, the predetermined criteria can include flatness, detachability from a substrate, and/or water stability (e.g., water solubility). In some embodiments, the viability characterization module 108 can include one or more machines that automatically evaluate the predetermined criteria (e.g., via optical imaging and/or testing). Alternatively, in some embodiments, the predetermined criteria can be evaluated in part or in whole by a human.

In some embodiments, the properties characterization module 110 can include means for determining (e.g., measuring or calculating) one or more properties of fabricated polymer composites. For example, the one or more properties can be related to potential or desired characteristics for applications in which the polymer composites may be used. In some embodiments, the characteristics can include physical characteristics (e.g., optical, mechanical, spatial, thermal, and/or fire resistance properties) and/or cost characteristics (e.g., component cost, fabrication cost, life cycle cost). In some embodiments, the properties characterization module 110 can include one or more machines that automatically determine the one or more properties. Alternatively, in some embodiments, the one or more properties can be determined in part or in whole by a human.

The design space screening module 112 can select a portion of the design space of mixture recipes for fabricated polymer composites, for example, based on input from the viability characterization module 108. In some embodiments, the design space screening module 112 can include a classifier, such as a support-vector machine (SVM) classifier. The data augmentation module 114 can provide in silico data augmentation, for example, of determined properties from the properties characterization module 110. In some embodiments, the data augmentation module 114 can employ a User Input Principle method to add virtual data points proximal to actual data points. The machine learning algorithm training module 116 can train a machine learning algorithm (e.g., artificial neural networks) based on the augmented data set (e.g., from data augmentation module 114).

In some embodiments, the design space screening module 112 can communicate with the robotic fabrication system 104. For example, the robotic fabrication system 104 can fabricate initial training polymer composites using mixture recipes within a reduced design space provided by the design space screening module 112. In some embodiments, the machine learning algorithm training module 116 can communicate with the robotic fabrication system 104. For example, the robotic fabrication system 104 can fabricate subsequent training polymer composites using mixture recipes provided by the machine learning algorithm training module 116.

FIG. 1B shows further details of another polymer composite discovery system 130. In the illustrated example, polymer composite discovery system 130 includes a natural material component source 132 (e.g., having natural materials S1-S4, although fewer or more are also possible), a robotic system 134, a viability characterization system 140, an input/output module 142, a screening module 144, a recipe selection module 150, a training module 156, a property characterization system 164, and an ANN prediction module 162. In the illustrated example, the screening module 144 includes a classifier module 146 and a design space selection module 148, while the training module 156 includes a data augmentation module 158 and an ANN training module 160. The recipe selection module 150 includes a random recipe module 152 and a model recipe module 154. In some embodiments, the input/output module 142, the screening module 144, the recipe selection module 150, the training module 156, the property characterization system 164, and the ANN prediction module 162 can be considered part of a machine learning system that communicates with the robotic system 134. For example, the robotic system 134 can include a controller 136 and an input/output module 138 in communication with input/output module 142, viability characterization system 140, and/or property characterization system 164.

In operation, the robotic system 134 can fabricate multiple candidate polymer composites using natural materials from component source 132, and the fabricated candidate polymer composites can be evaluated by viability characterization system 140. In some embodiments, the candidate polymer composites can have different mixture recipes that cover an available design space (e.g., in fixed increments on a weight percent basis), and each of the candidate polymer composites can be evaluated with respect to fabrication viability (e.g., flatness, substrate detachability, etc.) or other characteristics for a particular application (e.g., water stability). In the screening module 144, the classifier module 146 can train a classifier (e.g., SVM) based at least in part on information received from the viability characterization system 140 (e.g., grading of candidate polymer composites with respect to one or more predetermined criteria) via input/output module 142, and the design space selection module 148 can select a reduced design space for mixture recipes of subsequent training polymer composites using the trained classifier.

Using information from the design space selection module 148, module 152 of recipe selection module 150 can select mixture recipes within the reduced design space, for example, by randomly generating the mixture recipes. The selected mixture recipes can then be sent via input/output module 142 to the robotic system 134 for fabrication of an initial set of training polymer composites. The robotic system 134 can fabricate training polymer composites using natural materials from component source 132 according to the instructed recipes from recipe selection module 150, and the fabricated training polymer composites can be evaluated by property characterization system 164. In some embodiments, each of the training polymer composites can be evaluated with respect to physical properties (e.g., optical, thermal, mechanical, spatial, stability, durability, and/or fire resistance properties) or other properties desirable for a particular application (e.g., material cost, fabrication cost, life cycle cost, etc.). In the training module 156, the data augmentation module 158 can augment the data set of actual data points received via the input/output module 142 from the property characterization system 164, for example, by adding virtual data points, and the training module 160 can train one or more ANNs based at least in part on the augmented data set.

Using information from the training module 160, module 154 of recipe selection module 150 can select mixture recipes within the reduced design space, for example, by selecting a subset of mixture recipes suggested by the ANN after a particular learning loop. The selected mixture recipes can then be sent via input/output module 142 to the robotic system 134 for fabrication of a next set of training polymer composites, for example, to perform another learning loop for training the one or more ANNs. In some embodiments, once sufficient training has been performed (e.g., once a mean relative error is less than a predetermined threshold), one of the ANNs can be selected for ANN prediction module 162, for example, for use in predicting mixture recipes and/or composite properties for desired polymer composites. For example, as shown in the configuration 170 of FIG. 1C, the ANN prediction module 162 can be in communication with robotic system 134 and/or user interface 174 via a communication network 172 (e.g., wired and/or wireless). A proposed mixture recipe can be input to the ANN prediction module 162 via user interface 174 and communication network 172, and an estimate of one or more properties or characteristics for the polymer composite with the proposed mixture recipe can be returned by the ANN prediction module 162 to the user interface 174. Alternatively or additionally, proposed properties or characteristics can be input to the ANN prediction module 162 via user interface 174 and communication network 172, and one or more mixture recipes with the proposed properties or characteristics can be returned by the ANN prediction module 162 to the user interface 174.

### Polymer Composite Discovery Methods

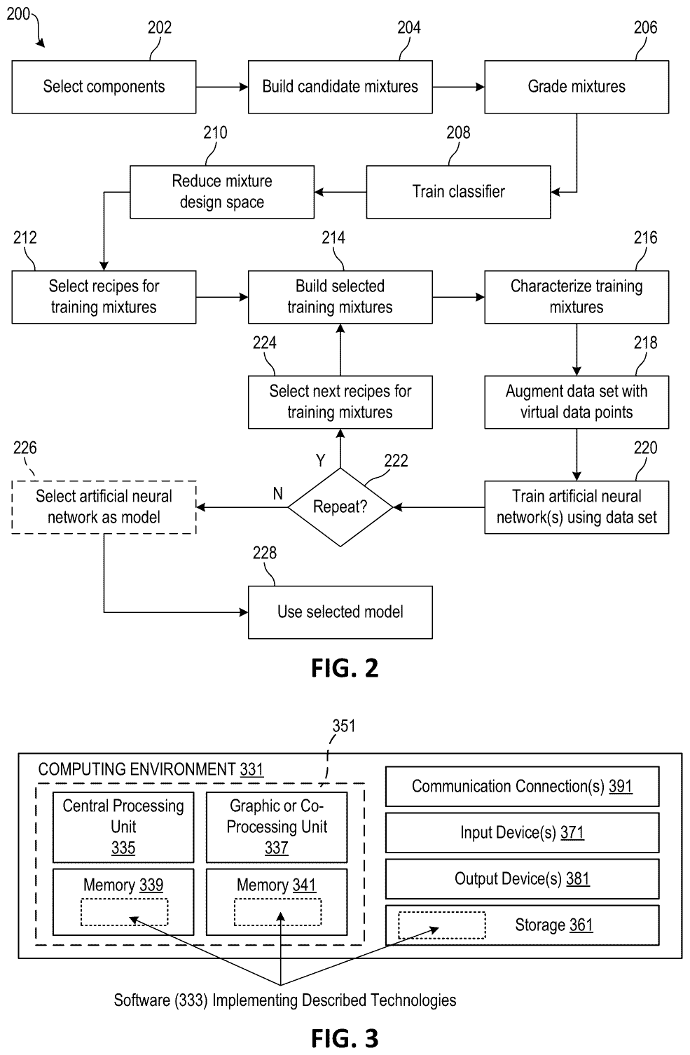

FIG. 2 illustrates aspects of a method 200 for discovery of polymer composites formed of natural materials. The method 200 can initiate at process block 202, where material components can be selected. In some embodiments, each of the components can be a natural material, for example, a naturally-occurring polysaccharide, a naturally-occurring protein, a naturally-occurring mineral, or a naturally-occurring alcohol. In some embodiments, the number of material components can be at least two, for example, four or more.

The method 200 can proceed to process block 204, where multiple candidate polymer composites can be fabricated using one or more robotic systems (e.g., a pipetting robot). In some embodiments, the candidate polymer composites can be formed of a mixture of the material components, each composite having a different recipe (e.g., ratio of components on a weight percentage basis). For example, the recipes for the candidate polymer composites can be varied in a regular manner (e.g., 2 wt. % increments) across an available design space (e.g., 0-100 wt. %). In some embodiments, the fabrication can include mixing together the material components (e.g., in solution) and then allowing the mixture to dry (e.g., ambient drying, oven drying, etc.). In some embodiments, the fabrication can also include incorporating ions into the mixture (e.g., metal ions, such as Ca²⁺), for example, to crosslink components. Alternatively or additionally, in some embodiments the fabrication can include densification of the polymer composite, for example, mechanical pressing (e.g., hot pressing, cold pressing, etc.).

The method 200 can proceed to process block 206, where each of the candidate polymer composites can be evaluated (e.g., graded) with respect to one or more predetermined criteria. In some embodiments, the predetermined criteria can include flatness of the candidate polymer composite (e.g., after drying and/or before densification) and/or detachability of the candidate polymer composite from an underlying substrate (e.g., polycarbonate, polystyrene, polytetrafluoroethylene, etc.). Alternatively or additionally, in some embodiments, the predetermined criteria can include water stability (e.g., to be stable when exposed to water or to readily dissolve when exposed to water).

The method 200 can proceed to process block 208, where a classifier can be trained based on the evaluation (e.g., grading) of the candidate polymer composites. In some embodiments, the classifier can be a support-vector machine (SVM) classifier. For example, the classifier can be used to predict the probability that a particular recipe of the polymer composite will have desired values for the predetermined criteria (e.g., an “A” grade with respect to flatness and detachability). The method 200 can proceed to process block 210, where the design space for mixture recipes for training polymer composites can be reduced using the trained classifier. For example, a threshold probability can be selected or otherwise input to the classifier, and the classifier can return a subset of the design space that satisfies the threshold probability (e.g., >75% probability of an “A” grade).

The method 200 can proceed to process block 212, where mixture recipes are selected for an initial set of training polymer composites. In some embodiments, the mixture recipes can be determined at random within the reduced design space. The method 200 can proceed to process block 214, where the training polymer composites are fabricated according to the determined mixture recipes. In some embodiments, the training polymer composites can be fabricated using one or more robotic systems, for example, the same robotic system(s) used to build the candidate polymer composites in process block 204.

The method 200 can proceed to process block 216, where the fabricated training polymer composites can be characterized with respect to one or more properties, for example, physical characteristics of the polymer composite. The physical characteristics can include but are not limited to optical properties (e.g., transmittance, reflectance, and/or absorption at different wavelengths in the electromagnetic spectra), fire resistance, mechanical properties (e.g., tensile strength, fracture strain, Young's modulus, hardness, etc.), and shape properties (e.g., thickness, density, etc.). In some embodiments, the characterization of process block 216 can include other evaluations, such as but not limited to material cost, fabrication, lifecycle analysis, and environmental stability. In some embodiments, the characterization of process block 216 can generate a data set, with each data point corresponding to one of the fabricated training polymer composites. In some embodiments, the characterization of process block 216 can be performed by one or more automated testing machines. Alternatively or additionally, the characterization of process block 216 can be performed manually, for example, a user or technician testing each fabricated polymer composite using separate instruments or testing platforms.

The method 200 can proceed to process block 218, where the data set from process block 216 can be augmented with virtual data points (e.g., in silico data augmentation). In some embodiments, the virtual data points can be determined using the User Input Principle (UIP) method. For example, the virtual data points can be for polymer composites having mixture recipes similar to the fabricated training polymer composites of process block 214, but that are not actually fabricated. In some embodiments, the number of virtual data points in the augmented data set can exceed the number of actual data points. For example, the ratio of virtual data points to actual data points in the augmented data set can be at least 1000:1.

The method 200 can proceed to process block 220, where the augmented data set can be used to train an artificial neural network (ANN). For example, the ANN can be trained through k-fold cross-validation (e.g., 5-fold cross-validation) with respect to the evaluated properties (e.g., property labels) and the mixture recipes (e.g., composition labels). In some embodiments, multiple ANNs can be simultaneously trained, for example, as members of an ANN committee. The method 200 can proceed to decision block 222, where it can be determined if a learning loop should be repeated. In some embodiments, the learning loop can be repeated if a mean relative error (MRE) of the trained ANN exceeds a predetermined threshold (e.g., 20%). Alternatively or additionally, the determination of whether to repeat the learning loop can be based on any other criteria, such as but not limited to a total number of learning loops, time/duration of the training, and/or user input.

If the learning loop is to be repeated, the method 200 can proceed from decision block 222 to process block 224, where mixture recipes can be selected for a next set of training polymer composites. In some embodiments, the mixture recipes within the reduced design space can be determined using the trained ANN. For example, to select targeted data points for the next active learning loop, the unfamiliarity of targeted data points can be evaluated by the ANN model based on a hybrid acquisition function (e.g., “A score” calculated based on the Euclidean distance between in-model and model-targeted composition labels and the prediction variance of the ANN committee). The data points with the highest evaluations (e.g., “A score”) can be selected. The next learning loop can then be executed by repeating process blocks 214-220 with the selected set of training polymer composites.

If the learning loop is not to be repeated, the method 200 can proceed from decision block 222 to optional process block 226, where an ANN can be selected as a prediction model. For example, where multiple ANNs in a committee are simultaneously trained, one of the ANNs in the committee can be selected in process block 226. In some embodiments, the ANN model with the lowest MRE can be selected as a “champion model” for use in subsequent polymer composition predictions in process block 228, for example, to predict a mixture recipe or one or more characteristics for a desired polymer composite. In some embodiments, a proposed mixture recipe can be input to the ANN, and the ANN can output an estimate of one or more physical characteristics for the desired polymer composite with the proposed mixture recipe. Alternatively or additionally, proposed physical characteristics can be input to the ANN, and the ANN can output one or more mixture recipes for a desired polymer composite having the proposed physical characteristics. In some embodiments, process block 226 can further include fabricating the polymer composite with the proposed or output mixture recipe, for example, using one or more robotic systems (e.g., the same robotic system(s) used in process block 204 and/or process block 214). Alternatively or additionally, in some embodiments, process block 228 can include characterizing influence of component materials on composite properties, for example, using Spearman's p or Shapley Additive Explanations.

Although blocks 202-228 of method 200 have been described as being performed once, in some embodiments, multiple repetitions of a particular process block may be employed before proceeding to the next decision block or process block. In addition, although blocks 202-228 of method 200 have been separately illustrated and described, in some embodiments, process blocks may be combined and performed together (simultaneously or sequentially). Moreover, although FIG. 2 illustrates a particular order for blocks 202-228, embodiments of the disclosed subject matter are not limited thereto. Indeed, in certain embodiments, the blocks may occur in a different order than illustrated or simultaneously with other blocks. In some embodiments, method 200 can include steps or other aspects not specifically illustrated in FIG. 2. Alternatively or additionally, in some embodiments, method 200 may comprise only some of blocks 202-228 of FIG. 2.

### Computer Implementation Examples

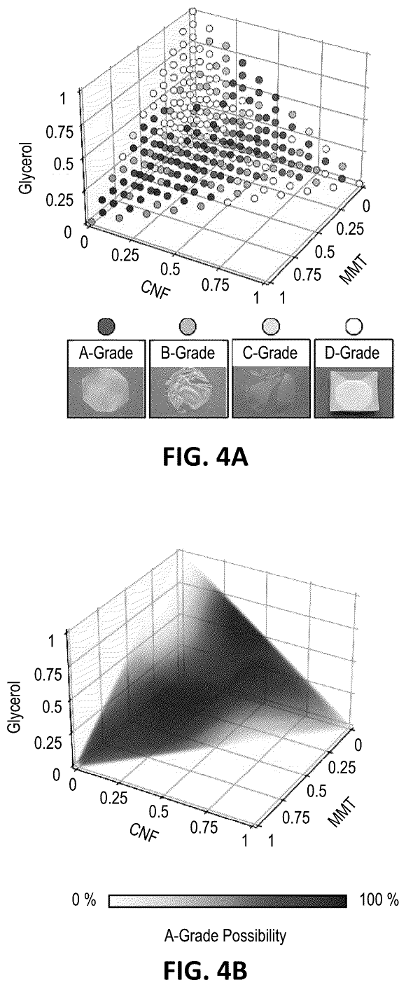

FIG. 3 depicts a generalized example of a suitable computing environment 331 in which the described innovations may be implemented, such as but not limited to aspects of robotic fabrication system 104, characterization system 106, design space screening module 112, data augmentation module 114, machine learning algorithm training module 116, controller 136, viability characterization system 140, property characterization system 164, screening module 144, training module 156, recipe selection module 150, prediction module 162, and/or method 200. The computing environment 331 is not intended to suggest any limitation as to scope of use or functionality, as the innovations may be implemented in diverse general-purpose or special-purpose computing systems. For example, the computing environment 331 can be any of a variety of computing devices (e.g., desktop computer, laptop computer, server computer, tablet computer, etc.).

With reference to FIG. 3, the computing environment 331 includes one or more processing units 335, 337 and memory 339, 341. In FIG. 3, this basic configuration 351 is included within a dashed line. The processing units 335, 337 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 3 shows a central processing unit 335 as well as a graphics processing unit or co-processing unit 337. The tangible memory 339, 341 may be volatile memory (e.g., registers, cache, RAM), non-volatile memory (e.g., ROM, EEPROM, flash memory, etc.), or some combination of the two, accessible by the processing unit(s). The memory 339, 341 stores software 333 implementing one or more innovations described herein, in the form of computer-executable instructions suitable for execution by the processing unit(s).

A computing system may have additional features. For example, the computing environment 331 includes storage 361, one or more input devices 371, one or more output devices 381, and one or more communication connections 391. An interconnection mechanism (not shown) such as a bus, controller, or network interconnects the components of the computing environment 331. Typically, operating system software (not shown) provides an operating environment for other software executing in the computing environment 331, and coordinates activities of the components of the computing environment 331.

The tangible storage 361 may be removable or non-removable, and includes magnetic disks, magnetic tapes or cassettes, CD-ROMs, DVDs, or any other medium which can be used to store information in a non-transitory way, and which can be accessed within the computing environment 331. The storage 361 can store instructions for the software 333 implementing one or more innovations described herein.

The input device(s) 371 may be a touch input device such as a keyboard, mouse, pen, or trackball, a voice input device, a scanning device, or another device that provides input to the computing environment 331. The output device(s) 381 may be a display, printer, speaker, CD-writer, or another device that provides output from computing environment 331.

The communication connection(s) 391 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

An integrated workflow that uses robotics and artificial-intelligence/machine-learning (AI/ML) predictions was realized to accelerate the discovery of all-natural plastic substitutes with programmable optical, thermal, and mechanical properties. Four Generally Recognized As Safe (GRAS) natural components, including cellulose nanofibers (CNFs), montmorillonite (MMT) nanosheets, gelatin, and glycerol, were selected as the building block units for the fabrication of various all-natural plastic substitutes. A material formed only of two-dimensional (2D) MMT nanosheets was rigid and lacked mechanical resilience, largely attributed to the weak interactions between nanosheets. To stabilize these MMT nanosheets, gelatin was incorporated as the second building block. Adjusting the MMT/gelatin ratios yielded composites with tunable tensile strengths, all of which were higher than the tensile strength of the MMT-only polymer. One-dimensional (1D) CNFs, which contained rich functional groups, were integrated into the composite in order to boost hydrogen bonding interactions. Introducing CNFs to the MMT/gelatin matrix further improved the tensile strength of resulting nanocomposites, outperforming the binary cases. However, these nanocomposites still exhibited ultimate strains less than 2.5%. Glycerol was then selected as the fourth building block to enhance the flexibility and ultimate strains of assembled nanocomposites. Other natural materials are also possible depending on desired performance, according to one or more contemplated embodiments.

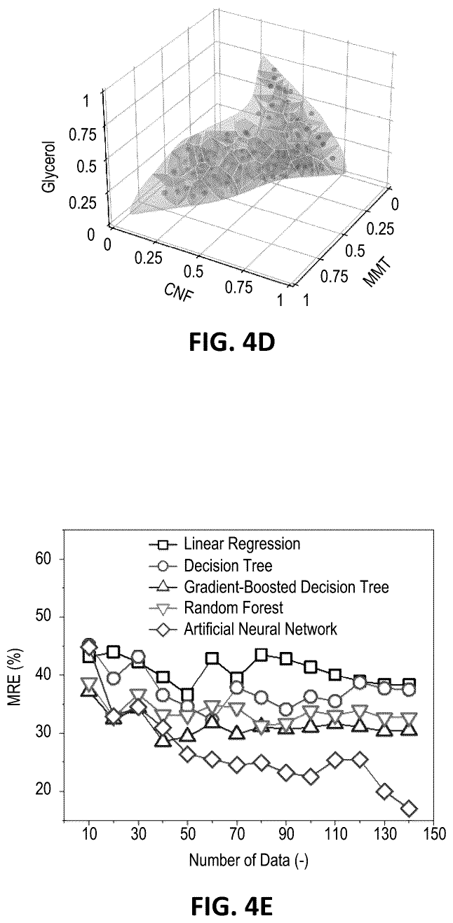

The average dimensions of MMT nanosheets were characterized to be ˜500×500 nm², and the average diameter and length of CNFs were 10 nm and 1-2 μm, respectively. The CNF, MMT, and CNF/MMT dispersions demonstrated high colloidal stability, and all of them showed the average zeta potentials lower than-30 mV over three months. Afterward, by casting the MMT/CNF/gelatin/glycerol mixtures followed by overnight evaporation at 40° C., the all-natural nanocomposite films were obtained, where CNFs were embedded within MMT multilayers. As shown in FIG. 5A-5C, by adjusting the MMT/CNF/gelatin/glycerol ratios, the transmittance spectra, fire resistances, and stress-strain curves of nanocomposite films varied in a non-linear and hard-to-predict manner. Three degrees of freedom (DOF) were recognized in the compositions, including CNF, MMT, and gelatin loadings. Once these three loadings were set, the glycerol loading can be determined. Using 2.0 wt. % as the step size for all CNF, MMT, gelatin, and glycerol loadings, 23,426 different composites would be necessary to build a database for varying the MMT/CNF/gelatin/glycerol ratios across three DOFs. Also, nine property labels (e.g., T_{UV}, T_{Vis}, T_{IR}, RR, σᵤ, ε_{f}, E, α, and β) would need to be collected for each composite from its respective transmittance spectrum, fire test result, and stress-strain curve. However, conducting such a large number of wet-lab experiments is impractical due to finite resources and time constraints.

Therefore, an integrated workflow, involving robotic automation and AI/ML algorithms, was implemented to construct a high-accuracy prediction model, facilitating the discovery of suitable biodegradable nanocomposites for diverse plastic replacements. In particular, an automated pipetting robot was first commanded to prepare 286 nanocomposites with varying CNF/MMT/gelatin/glycerol ratios, and the film qualities were evaluated to train a support-vector machine (SVM) classifier. Next, through 14 active learning loops with data augmentation, 135 kinds of all-natural nanocomposites were stagewise fabricated, enabling the construction of an artificial neural network (ANN) model with high prediction accuracy across the entire design space. By harnessing the model's predictive power, two-way design tasks were demonstrated, including (1) accurately predicting multiple characteristics of an all-natural nanocomposites from its composition and (2) automatically suggesting suitable biodegradable plastic alternatives with user-designated features. By inputting specific property criteria, the prediction model was able to discover suitable all-natural substitutes for diverse plastic replacements, without the need of iterative optimization experiments. These included transparent badge holders (transparency >90%), clear file folders (transparency >80% and strain >5%), transparent shopping bags (transparency >75% and strength >100 MPa), translucent lamp shades (transparency <70% and strength >80 MPa), transparent air pillows (transparency >80%, strength >25 MPa, and strain >25%), non-flammable battery packages (transparency >75%, strength >100 MPa, and high fire resistance), and UV-blocking chemical packages (UV absorption >95%, strength >100 MPa, and high fire resistance). The specific polymer composite recipes used to construct the above noted plastic replacement examples can be found in the underlying priority application, U.S. Application No. 63/487,489 (e.g., Table S8), which recipes are incorporated by reference herein.

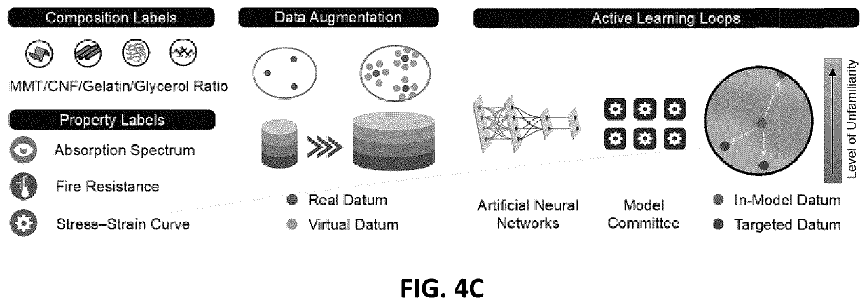

To construct the high-accuracy prediction model, an AI/ML framework was developed using (1) boundary definition, (2) active learning, and (3) in silico data augmentation. The first step was to define the boundaries of a feasible design space, during which an automated pipetting robot was commanded to prepare a library of MMT/CNF/gelatin/glycerol mixtures with varying ratios. The pipetting robot prepared 286 mixtures within 6 hours (4 components, with a step size of 10 wt. %). The robot-prepared solutions were then cast onto planar substrates (e.g., polystyrene) and left to evaporate overnight. Afterward, based on the detachability and flatness of nanocomposite films (see METHODS below), 286 samples were categorized into four grades (inset of FIG. 4A), ranging from (1) detachable and flat ones (A-grade) to (2) detachable yet curved ones (B-grade), (3) detachable yet fractured ones (C-grade), and (4) non-detachable ones (D-grade). Within the 286 samples, there were 132 A-grades, 36 B-grades, 46 C-grades, and 72 D-grades.

When polycarbonate petri dishes were switched for hydrophobic polystyrene substrates, fewer nanocomposite films were detached and achieved A-grade conditions. For example, the use of hydrophobic polystyrene substrates led to 32% of A-grade nanocomposites (18 out of 56 MMT/CNF/gelatin/glycerol ratios). In contrast, the use of polycarbonate petri dishes yielded only 18% A-grade nanocomposites (10 out of 56 ratios). As a result, using polycarbonate petri dishes led to a smaller feasible design space. To broaden the feasible design space, hydrophobic polystyrene substrates were used to prepare the all-natural plastic substitutes in subsequent active learning loops. However, other substrates may be used for different polymer composite compositions and/or different applications, according to one or more contemplated embodiments.

The discrete grades were then input to train the SVM classifier, in particular, to locate the maximal-margin hyperplanes between the data points with different grades. Three steps were involved in constructing the SVM classifier, including (1) selecting a kernel function, (2) optimizing SVM hyperparameters, and (3) retraining the SVM classifier with all 286 data points. In this work, as the collected grades were not shown to be linear, a kernel function was used to map low-dimension data points into a higher dimensional feature space to find the optimal hyperplanes with maximal margin distances. For the first step, a radial basis function (RBF) was selected as the kernel function to deal with the non-linear data points. Afterwards Bayesian optimization involving Gaussian processes and a 5-fold cross validation was used to adjust the hyperparameter values. For the last step, the optimal SVM classifier was trained by inputting 286 grades and achieved a testing accuracy of 93% (using 35 testing data points).

The trained SVM classifier was able to predict the possibility of getting an A-grade nanocomposite film under a specific MMT/CNF/gelatin/glycerol ratio. The SVM classifier had a high prediction accuracy of >94% examined by a set of testing data points that were never input to SVM. As shown in FIG. 4B, by predicting the A-grade possibilities across the design space, a three-dimensional (3D) heatmap was produced. By setting the possibility threshold of getting A-grade nanocomposites to be 75%, a 3D, irregular feasible design space was defined and held ˜48% of the entire design space. In the AI/ML framework, the SVM classifier served as a screening layer to allow the prediction model to only output MMT/CNF/gelatin/glycerol ratios that led to A-grade nanocomposite films.

Unlike other data-rich systems with higher tolerance of experimental failure, it would take much time and effort to re-do the fabrication of all-natural nanocomposites, if the prediction model suggests the MMT/CNF/gelatin/glycerol ratios that are on the margin of the discrete phase diagram. Therefore, SVM was used to transform the discrete grade diagram into a possibility heat map. Moreover, as shown in FIG. 4E, a prediction model based on linear regression cannot accurately predict the property labels of all-natural nanocomposites (e.g., showing a high mean relative error (MRE) of 38.3% after active learning loops). In contrast, a prediction model employing an ANN committee demonstrated a much lower MRE of 17.0% after active learning loops, clearly demonstrating advantages of using an ANN committee for such a non-linear and multi-DOF system. In addition, the use of data augmentation can help address data scarcity and resolve issues of potential overfitting, especially when using a small dataset. In particular, data augmentation can be used to create adequate virtual data points and enable the prediction model to be trained with both real and virtual data points, resulting in a higher prediction accuracy. For example, the model prediction accuracy (in terms of MRE) after data augmentation can be from >55.0% to 17.0% after data augmentation, as shown in FIG. 4F.

Within the feasible design space, multiple active learning loops and in silico data augmentation were executed to collect representative data points and stagewise construct a prediction model. As illustrated in FIG. 4C, the active learning loops were initiated by commanding the pipetting robot to prepare 10 mixtures with random ratios of MMT, CNF, gelatin, and glycerol. After overnight drying, 10 nanocomposite films were obtained, and their MMT/CNF/gelatin/glycerol ratios were recorded as the “composition” labels. Afterward, each nanocomposite film underwent optical, fire-resistant, and mechanical characterizations. In particular, the transmittance spectrum of each nanocomposite film was characterized, and the transmittance values at 365, 550, 950 nm were extracted as the “spectral” labels (T_{UV}, T_{Vis}, and T_{IR}), respectively. The fire resistance of each nanocomposite film was also examined through a modified ASTM D6413 fire test (ASTM D6413/D6413M-15, published November 2022 and entitled “Standard Test Method for Flame Resistance of Textiles (Vertical Test),” which is incorporated herein by reference). The residual ratio (RR) was recorded as the “fire” label, according to:

$$RR = {A}^{′} / A , \qquad ( 1 )$$

where A and A′ are the sample dimensions before and after the fire test, respectively. Finally, the stress-strain curve of each nanocomposite film was characterized by performing a tensile test. Several mathematic equations were tested to fit the stress-strain curves, and the cubic Bézier equation was selected due to the highest coefficient of determination (R²=0.995). Five cubic Bézier parameters-including ultimate tensile strength (σᵤ), fracture strain (ε_{f}), Young's modulus (E), and two shape parameters (α and β)—were extracted as the “mechanical” labels. In summary, one nanocomposite film produced one data point containing 4 composition, 3 spectral, 1 fire, and 5 mechanical labels. In the initial round, 10 data points were collected.

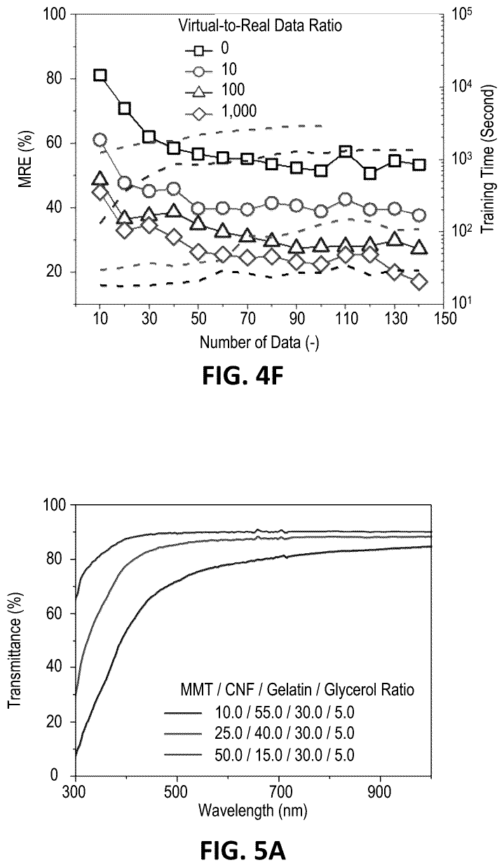

As noted above, to improve model's learning efficiency and address potential overfitting issues when using a small data set, an in silico data augmentation method was introduced to synthesize “virtual” data points to augment the collected data points. In particular, a User Input Principle (UIP) method was used. The UIP method is based on the natural principles proposed by expert users. For example, the property labels of an composites stay approximately constant over very small variations across specific composition label(s). As shown in FIGS. 6A-6C, when the MMT/CNF/gelatin/glycerol ratio varied from 1.3/48.8/24.9/25.0 to 4.3/47.9/23.9/23.9, the resultant all-natural nanocomposites exhibited similar property labels. Also, there were measurement variations of 9 property labels. As shown in FIG. 6D, even under the same composition labels, the collected property labels could have 10-20% variances (e.g., ˜5% in the spectral labels, ˜3% in the fire labels, and ˜15% in the mechanical labels) across multiple all-natural nanocomposite replicates. Based on 135 data points collected during active learning, the UIP method was used to synthesize 1,000-fold virtual data by introducing Gaussian noises into all composition and property labels. Both virtual and real data points were used as the training data for an artificial neural network (ANN) model through 5-fold cross-validation.

Then, to suggest the targeted data points for the next active learning loop, the ANN model evaluated the unfamiliarity level of targeted data points based on a hybrid acquisition function (so-called A Score) as:

$$A Score = \hat{L} \times \hat{σ} , \qquad ( 2 )$$

where \hat{L} denotes the Euclidean distance between in-model and model-targeted “composition” labels, and ô denotes the prediction variance of the ANN committee. For the next active learning loop, the data points with the highest A Scores in the feasible design space were selected.

For example, the acquisition function can be introduced in the active learning loops to suggest the targeted data points with the highest uncertainty in the feasible design space, where the acquisition function A Score was defined as:

$$A Score = {L}_{2} \times \hat{σ} , \qquad ( 3 )$$

where L₂ denotes the shortest mathematical distance (also called Euclidian distance) between current composition labels (within the dataset of prediction model) and targeted composition labels (not yet included in the dataset of prediction model). L₂ can be calculated as:

$${l}_{2} = \sqrt[2]{{min}_{i ∈ N} [ {( [ \begin{matrix}{CNF}_{i} \\ {MMT}_{i} \\ {GEL}_{i} \\ {GLY}_{i}\end{matrix} ] - [ \begin{matrix}{CNF}_{j} \\ {MMT}_{j} \\ {GEL}_{j} \\ {GLY}_{j}\end{matrix} ] )}^{2} ]} , \qquad ( 4 )$$

where N is the cumulative number of data points in current dataset, CNFᵢ, MMTᵢ, GELᵢ, and GLYᵢ represent CNF loading, MMT loading, gelatin loading, and glycerol loading of one known data point (i) within the prediction model, and CNFⱼ, MMTⱼ, GELⱼ, and GLYⱼ are the composition labels of one targeted data point (j) outside the prediction model. On the other hand, \hat{σ} denotes the variance of predicted property labels from the ANN committee, which is given as:

$$\hat{σ} = \sqrt[2]{\frac{1}{M} {\sum }_{j = 1}^{M} {( [ \begin{matrix}{Output}_{{T}_{UV}}^{j} \\ {Output}_{{T}_{Vis}}^{j} \\ {Output}_{{T}_{IR}}^{j} \\ {Output}_{RR}^{j} \\ {Output}_{{ϵ}_{f}}^{j} \\ {Output}_{{σ}_{u}}^{j} \\ {Output}_{E}^{j} \\ {Output}_{α}^{j} \\ {Output}_{β}^{j}\end{matrix} ] - [ [ \begin{matrix}{Output}_{{T}_{UV}}^{Ave} \\ {Output}_{{T}_{Vis}}^{Ave} \\ {Output}_{{T}_{IR}}^{Ave} \\ {Output}_{RR}^{Ave} \\ {Output}_{{ε}_{f}}^{Ave} \\ {Output}_{{σ}_{u}}^{Ave} \\ {Output}_{E}^{Ave} \\ {Output}_{α}^{Ave} \\ {Output}_{β}^{Ave}\end{matrix} ] ] )}^{2}} \qquad ( 5 )$$

where M is the total ANN number in the committee (M=5), Output_{T}_{_{UV}}^{j}, Output_{T}_{_{Vis}}^{j}, Output_{T}_{_{IR}}^{j}, Output_{RR}^{j}, Output_{ε}_{_{f}}^{j}, Output_{σ}_{ᵤ}^{j}, Output_{E}^{j}, Output_{α}^{j}, and Output_{β}^{j} are the output property labels predicted by the j^{th} decision program on basis of the composition labels of a targeted data point, Output_{T}_{_{UV}}^{Ave}, Output_{T}_{_{Vis}}^{Ave}, Output_{T}_{_{IR}}^{Ave}, Output_{RR}^{Ave}, Output_{ε}_{_{f}}^{Ave}, Output_{σ}_{ᵤ}^{Ave}, Output_{E}^{Ave}, Output_{α}^{Ave}, and Output_{β}^{Ave} are the average property labels predicted by the ANN committee on basis of the composition labels of a targeted data point.

After determination of the targeted data points for the next active learning loop, the pipetting robot was re-activated and followed the model-suggested “composition” labels to prepare a new set of MMT/CNF/gelatin/glycerol mixtures. After cast drying, each nanocomposite film underwent similar spectral, fire, and mechanical characterizations, and the UIP method was again applied to synthesize virtual data points. With the updated dataset, the prediction model was re-trained and suggested another set of targeted data points with the highest A Scores for the next active learning loop. With robot-assisted experiments, one active learning loop (from sample preparation to model training) took an average of two days. In this work, a total of 14 active learning loops were conducted, and 135 all-natural nanocomposite films were stagewise fabricated, resulting in ˜140,000 real and virtual data points in the database.

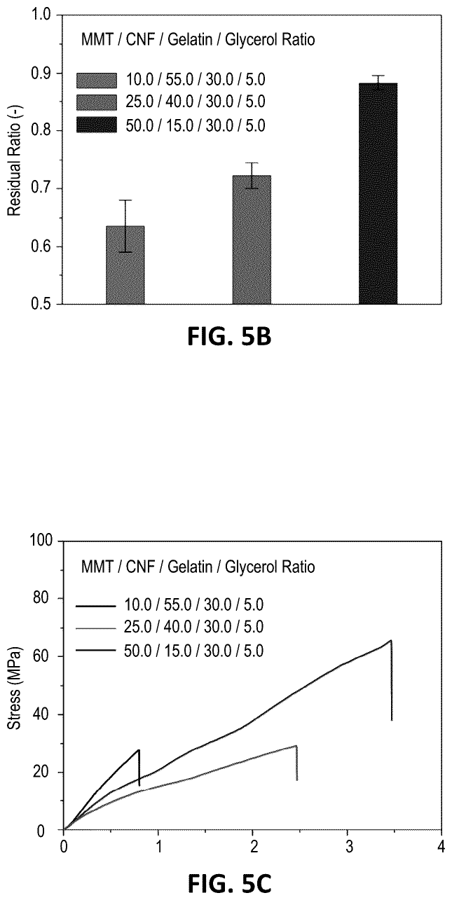

During the active learning loops, the evolving prediction model was monitored from two aspects: (1) the degree of data distribution and (2) the accuracy of multi-property prediction. To visualize how data points were collected and distributed during active learning loops, 3D diagrams of Voronoi tessellation were adopted. As shown in FIG. 4D and FIG. 7, the average cell volumes and their volume variances continued to decrease as the loop number increased, implying that the AI/ML framework was able to suggest the data points in different sub-regions and avoid forming uninformative data clusters. Next, the accuracy of multi-property prediction was evaluated using a set of testing data points (that were never input to ANN). By inputting the “composition” values of testing data points, the prediction model outputs the “optical”, “fire”, and “mechanical” labels, which were compared with the actual values of testing data points. The deviation between model-predicted property labels and actual property values was quantified using a mean relative error (MRE), defined as:

$$MRE = \frac{1}{N} {\sum }_{i = 1}^{N} \vert \frac{{output}^{i} - {E}^{i}}{{E}^{i}} \vert , \qquad ( 6 )$$

where N is the cumulative number of testing data, outputⁱ is the model-predicted property labels based on a testing datum (i), and Eⁱ is the actual property values of a testing datum (i). A smaller MRE value indicates higher prediction accuracy and vice versa. As demonstrated in FIG. 4E, after 14 active learning loops, the MRE decreased to around 17%, which was close to some measurement variations (FIG. 6D, around 12% in the T_{UV} label and around 15% in the ε_{f} label). Among other prediction models based on linear regression, decision tree, gradient-boosting decision tree, and random forests algorithms, the ANN model demonstrated the lowest MREs and the highest accuracy of multi-property prediction.

FIG. 4F shows that the ANN model without data augmentation presented a high MRE of >55% after 14 active learning loops, mainly due to a small amount of training data points that caused model overfitting. Moreover, the active learning sampling recommended the MMT/CNF/gelatin/glycerol ratios with a >95% successful rate in producing A-grade nanocomposites. In contrast, other sampling methods exhibited much lower successful rates <60%. Subsequently, the UIP method was conducted at a 1-to-1,000 ratio, and the data points from different sampling methods were input to train multiple ANN models. Trained by the data points from the active learning sampling, the ANN model demonstrated higher learning efficiency and the lowest MRE values. The optimal virtual-and-real data ratio was determined to be about 1,000, which maximized the learning efficiency while keeping a short loop time. On average, completing one loop took approximately 2.5 days. When the virtual-and-real data ratio further increased to 5,000 and 10,000, the model training and optimization for one loop took over 4 and 7 days, respectively.

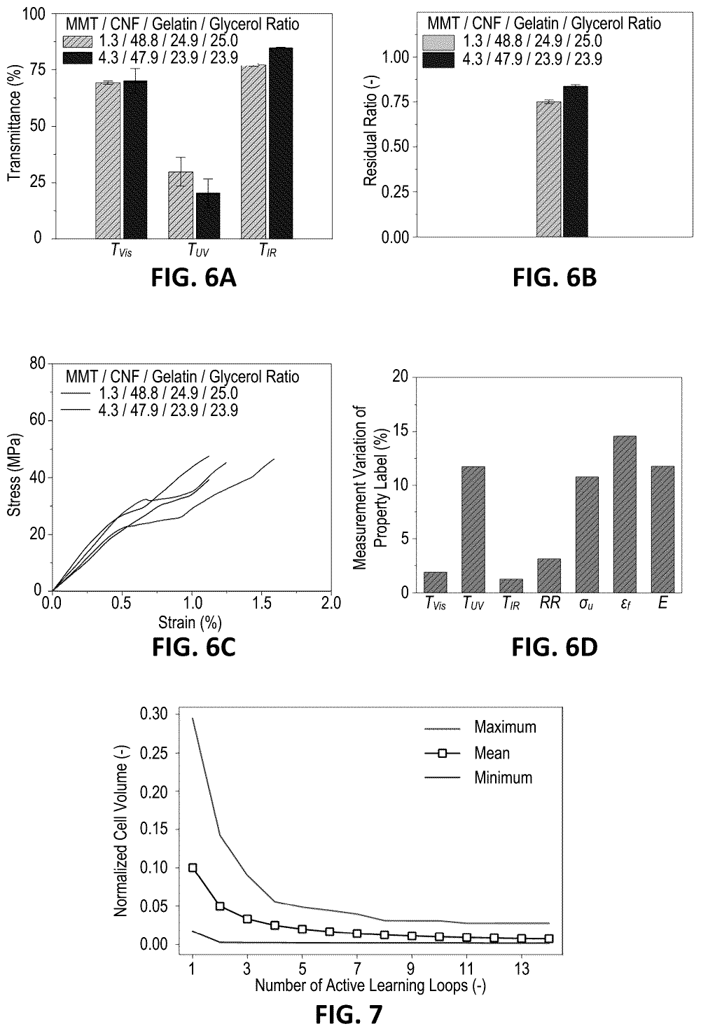

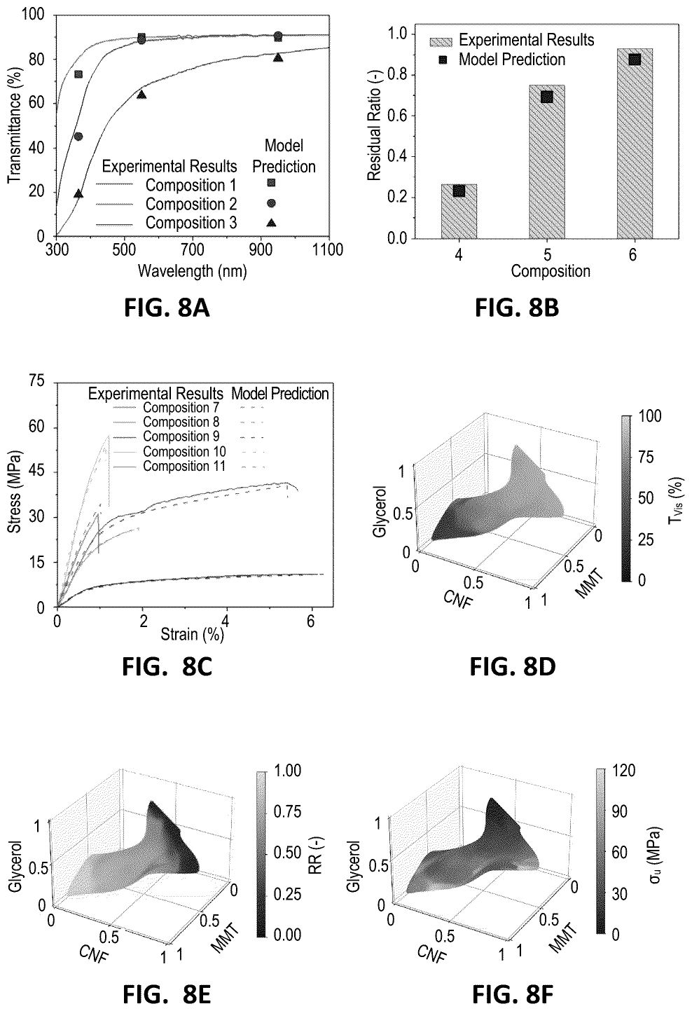

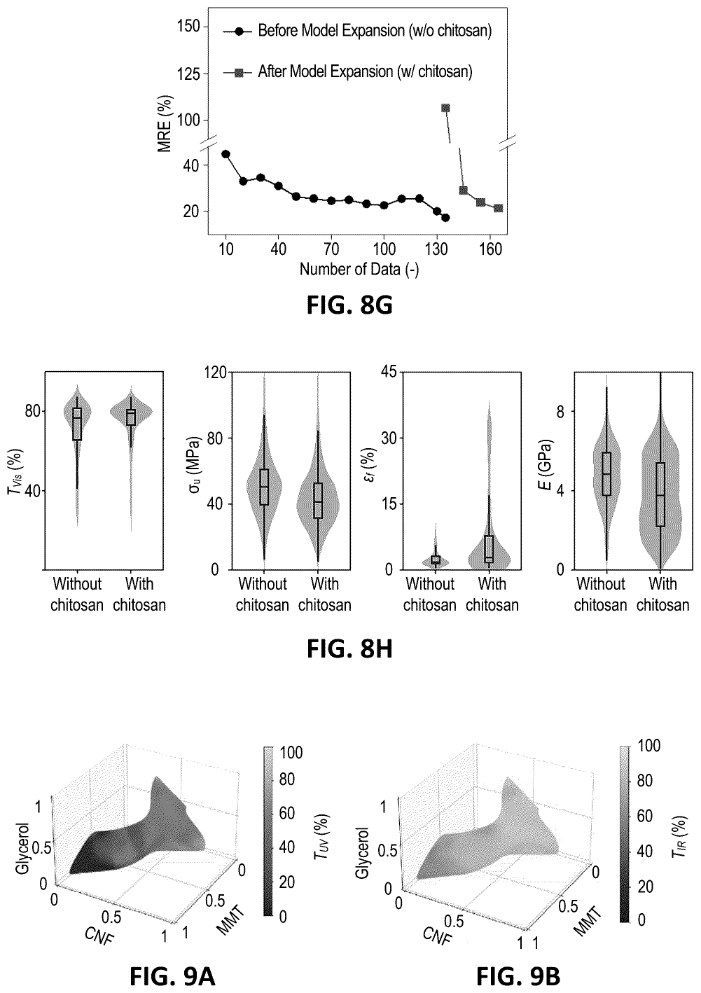

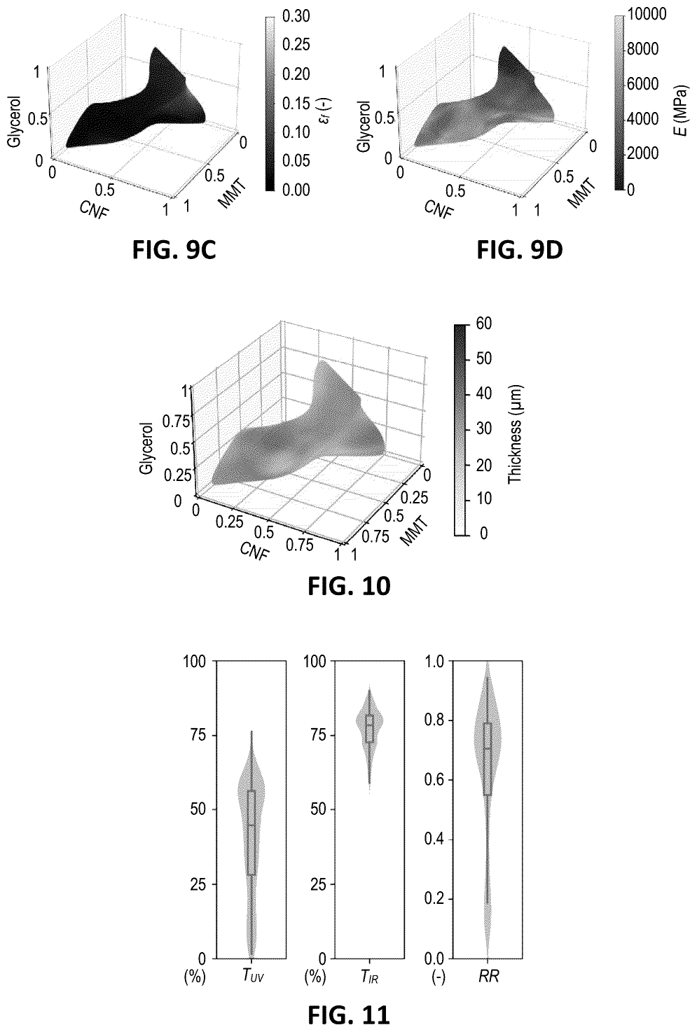

The ANN model with the lowest MRE of 17% was selected as “the champion model,” which was utilized to accelerate the discovery of all-natural plastic nanocomposites with programmable properties. With high accuracy of multi-property prediction, the champion model was employed to perform two-way design tasks, including (1) predicting optical, thermal, and mechanical properties of an all-natural nanocomposites based on its designated composition and (2) automatically suggesting suitable compositions for designing various all-natural substitutes with desired property criteria. As shown in FIGS. 8A-8C, the champion model was able to predict the optical transmittances, fire resistances, and stress-strain curves of multiple all-natural nanocomposites, which matched the experimental results. By inputting all possible compositions within the feasible design space, the champion model produced a set of 3D heatmaps that visually represented the spatial distributions of all property labels, including T_{UV} (FIG. 9A), T_{Vis} (FIG. 8D), T_{IR} (FIG. 9B), RR (FIG. 8E), σᵤ (FIG. 8F), ε_{f} (FIG. 9C), and E (FIG. 9D). Also, FIG. 10 presents the distribution of thickness labels, indicating that the thicknesses of all-natural nanocomposites were highly correlated to their compositions. FIGS. 8G and 11 further show that, through simply adjusting the MMT/CNF/gelatin/glycerol ratios, the optical, thermal, mechanical properties of all-natural nanocomposites were highly tunable across wide ranges (e.g., 20%<T_{Vis}<93%, 0<RR<1, 1 MPa<σᵤ<120 MPa, 0.5 GPa<E<9.9 GPa).

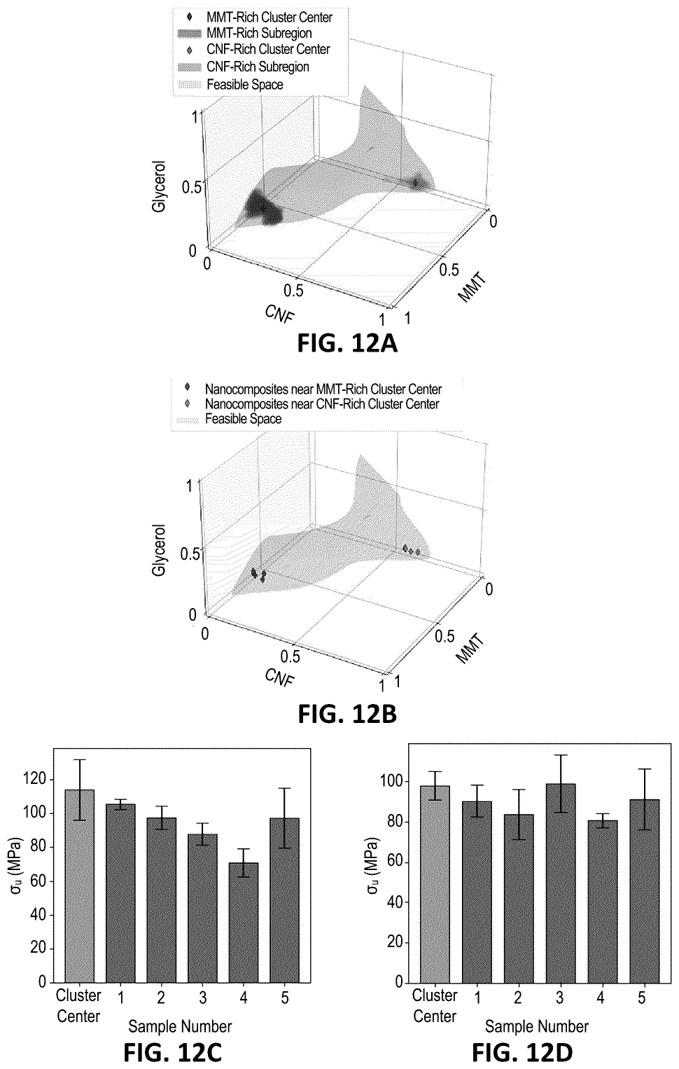

With high prediction accuracy, the champion model was adopted to accelerate the discovery of all-natural nanocomposites with superior du. In particular, through clustering analyses, the champion model suggested two suitable compositions (see FIGS. 12A-12D): one with a high MMT loading (MMT/CNF/gelatin/glycerol=64.2/6.7/23.8/5.3), and the other with a high CNF loading (3.7/61.8/28.4/6.1). For example, a density-based spatial clustering of applications with noise (DBSCAN) algorithm was used to search the clusters with high σᵤ values in the feasible design space. The central component to the DBSCAN algorithm is the concept of “core samples,” which are the samples in the high-density areas. There are two important parameters to the DBSCAN algorithm: (1) min_samples and (2) eps. Higher min_samples or lower eps values indicate a higher density needed to form a cluster. In this work, the min_samples and eps values were set as 20 and 0.15, respectively. The eps parameter was chosen appropriately, which was used to control the local neighborhood of the data points. When chosen too small, most data points will not be clustered at all; when chosen too large, it causes close clusters to be merged into one cluster, and eventually the entire data set to be returned as a single cluster. By following two model-suggested compositions, MMT-rich and CNF-rich nanocomposites were successfully fabricated, and their average σᵤ values were characterized as 114±18 and 98±7 MPa (from 5-10 replicates), respectively, as shown in FIG. 8H. Moreover, the measured σᵤ values were similar to the model-predicted σᵤ labels and experimentally validated to be superior to other nanocomposites in the design space, as reflected in FIGS. 12A-12D.

To further strengthen the MMT-rich and CNF-rich nanocomposites, two-step treatments were conducted, including (1) ionic crosslinking (e.g., reaction for 12 hours) using divalent cations (e.g., Ca²⁺) and (2) heat pressing (e.g., at 80° C. under 40 MPa for 8 hours). As shown in the cross-sectional SEM images (the inset of FIG. 8H), both MMT-rich and CNF-rich nanocomposites were largely densified after the two-step treatments, with more hydrogen bonds induced. After the two-step treatments, the average σᵤ values were significantly improved to 468.6±52.6 MPa (from 7 densified MMT-rich nanocomposites, with the highest σᵤ of 520.7 MPa) and 463.0±35.7 MPa (from 9 densified CNF-rich nanocomposites, with the highest σᵤ of 521.0 MPa). Additionally, the densified MMT-rich nanocomposites showed great fire resistance (with the RR of 0.99), while the densified CNF-rich nanocomposites showed high visible-light transmittance (with the T_{Vis} of 89.9%).

The selection of building blocks (e.g., constituent natural materials) can play a role in determining the achievable functions of the resulting all-natural plastic substitutes. To further enrich the portfolio of all-natural plastic substitutes, a model expansion method was applied to incorporate chitosan as the fifth building block. As shown in FIG. 8G, the prediction model guided three additional active learning loops to integrate the new DOF (e.g., chitosan loading) into the model's predictions. Throughout the model expansion phase, 133 experiments were conducted: 90 to refine the SVM classifier and 43 to retrain the ANN-based model. This model expansion process spanned approximately 13 days.

As shown in FIG. 8G, the prediction model maintained high predictive accuracy after the model expansion phase, with the MRE decreasing from 107% to 21% after five loops. As shown in FIG. 8H, the incorporation of chitosan elevated the ultimate strains of model-predicted substitutes from 15% (without chitosan) to 34% (with chitosan). Through strategic selection of new components or structural/physical parameters combined with the model expansion method, the prediction model expanded its design space and broadened the range of achievable functions. By utilizing the expanded model to suggest the suitable recipes of all-natural substitutes with high strains, two additional all-natural plastic substitutes were fabricated for clear file folders (e.g., T_{Vis}>80% and ε_{f}>5%; MMF/CNF/chitosan/gelatin/glycerol ratio of 2.3/1.5/42.8/51 0.7/1.7 wt. %) and transparent air pillows (e.g., T_{Vis}>80%, σᵤ>25 MPa, and ε_{f}>25%; MMF/CNF/chitosan/gelatin/glycerol ratio of 0.0/20.8/55.1/8.4/15.7 wt. %). However, expanding the model necessitates more active loops, leading to higher time and cost implications.

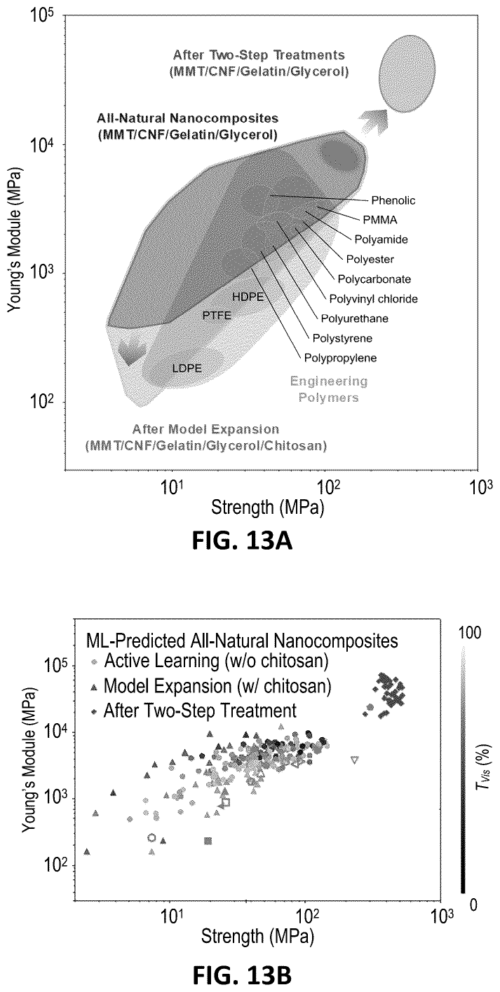

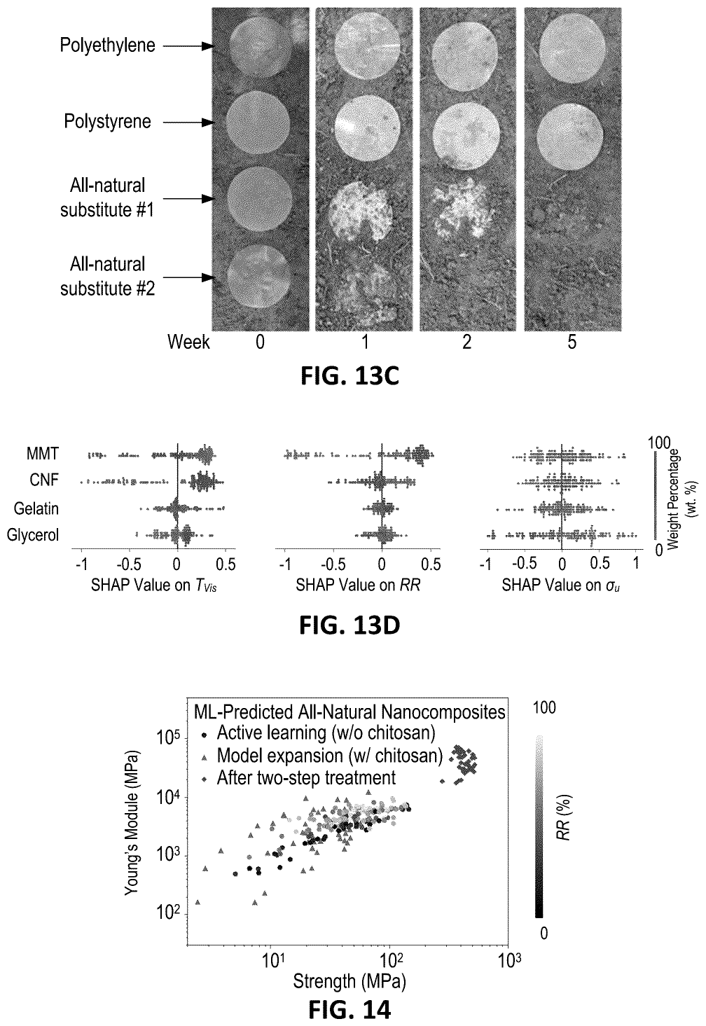

FIG. 13A shows the Ashby diagram that displays σᵤ and E of various engineered polymers (including plastics) and fabricated all-natural substitutes. Using AI/ML predictions, a library of all-natural substitutes was developed to satisfy a mechanical design region of 1<σᵤ<120 MPa and 0.5<E<9.9 GPa. After the two-step treatments, the model-suggested substitutes were further strengthened, and the design region was extended into the ranges of 278<σᵤ<521 MPa and 17.5<E<71.7 GPa. The champion model was able to suggest suitable composition labels to fabricate various all-natural substitutes with desired σᵤ and E values, which matched multiple non-biodegradable petrochemical plastics, including phenolic, poly(methyl methacrylate) (PMMA), polystyrene (PS), polyvinyl chloride (PVC), polycarbonate (PC), polyamide (PA), polyurethane, and polypropylene (PP). Compared with prior developed biodegradable plastic substitutes, the disclosed robotics/ML integrated approach was able to discover a set of >150 all-natural substitutes that covered the entire sub-region(s) of the Ashby diagram, enabling a wide range of plastic replacements, as shown in FIG. 13B. However, in contrast to the disclosed approach, prior developed biodegradable plastic substitutes were based on repetitive design of experiments, which resulted in scattered data points in the Ashby diagram. Note that the dot colors represent the T_{Vis} and RR values of each all-natural substitute, respectively, in FIGS. 13B and 14.

To demonstrate the power of multi-property prediction, the champion model was employed to automate the inverse design of all-natural plastic substitutes with programmable optical, fire-resistant, and mechanical properties. As previously noted, multiple plastic products were targeted to be replaced, including (1) transparent badge holders, (2) clear file folders, (3) transparent shopping bags, (4) translucent lamp shades, (5) transparent air pillows, (6) non-flammable battery packages, and (7) UV-blocking chemical packages. Every model-recommended all-natural plastic substitute exhibited optical transparency, fire retardancy, and mechanical resilience in line with the diverse design criteria. For example, for the replacement of shopping bag, the all-natural substitutes were required to be highly transparent and mechanically strong (e.g., T_{Vis}>90% and σᵤ>100 MPa). For the replacement of chemical packaging, the all-natural substitutes were specialized to have low UV transmittances, high fire retardancy, and strong tensile strengths (e.g., T_{UV}>90%, RR>0.9, ε_{f}>5%, and σᵤ>100 MPa). By inputting these design criteria, the champion model was able to automate the inverse design to find the most suitable all-natural substitutes via clustering analyses. By following the model-suggested compositions, various all-natural substitutes were produced in large areas (e.g., with dimensions of 53 cm×38 cm). Programmed by the champion model, both all-natural substitutes for specialized battery and chemical packaging were fabricated with high flame retardancy (e.g., capable of direct ethanol flame contact for minutes).

To examine the biodegradability of all-natural substitutes, two samples with different MMT/CNF/gelatin/glycerol ratios were buried in soil, along with PS and polyethylene films as the positive controls. After two weeks, the all-natural plastic substitutes lost >60% of their original weight. After five weeks, both all-natural substitutes were completely decomposed, as the natural macromolecules (e.g., CNFs, gelatin, and glycerol) gradually broke down due to various microorganisms (e.g., bacteria, fungi, protozoa, nematodes, earthworms, and arthropods), while the petrochemical plastics remained intact, as shown in FIG. 13C.

In addition to high biodegradability, the biocompatibility of all-natural plastic substitutes was tested through multiple cytotoxicity experiments on L929 cells. These experiments included lactate dehydrogenase (LDH) assays, 3-(4,5-dimethylthiazol-2-yl)-2,5-diphenyltetrazolium bromide (MTT) assays, and live/dead cell assays. For the LDH and MTT assays, six all-natural substitutes were immersed in culture media overnight. Then, the media were extracted to culture L929 cells, and clean culture medium and triton X-100 were used as the negative and positive controls, respectively. All of the all-natural substitute extracts exhibited similar LDH and MTT levels as clean culture medium. For the live/dead cell assays, >95% of live cells were observed using all-natural substitute extracts, indicating that no cytotoxic substances were released to affect cell viability and survival.

The fabricated all-natural plastic alternatives also demonstrated long shelf lives (e.g., at least 6 months), as well as excellent stability with respect to environmental factors. For example, the properties of all-natural plastic substitutes remained stable under direct sunlight after 8 days. In addition, the SVM classifier was constructed to design the all-natural plastic substitutes with different water stability levels. In particular, water stability tests were performed for 132 kinds of all-natural nanocomposites spanning the entire feasible design space. The water stability tests involved immersing the all-natural nanocomposites in 1 vol. % of acetic acid solution and subjecting them to continuous shaking for 2 days. Afterwards, the shape retention conditions of 126 all-natural nanocomposites were evaluated. When the all-natural nanocomposites stayed intact and preserved their original shapes, their water stability was categorized to the “intact” level. In contrast, if the sample was fractured, partially dissolved, or completely dissolved, its water stability was categorized to the “dissolvable” level. Then, these water stability data were input to train the SVM classifier, which generated a heatmap indicating the possibility of producing an all-natural nanocomposite with high water stability. This SVM model could be useful for tailoring the design of nanocomposites, for example, to be more water-stable or to readily degrade in water.

Several data-scientific insights were generalized by SHapley Additive explanations (SHAP) model interpretation and validated by molecular dynamics (MD) simulations. Through strategic selections of new components combined with a model expansion method, the prediction model continually expanded its design space and broadened the range of achievable functions. The disclosed approach, involving robot-assisted experiments, data science, and simulation tools, offers an unconventional design platform to accelerate the discovery of eco-friendly, biodegradable plastic substitutes.

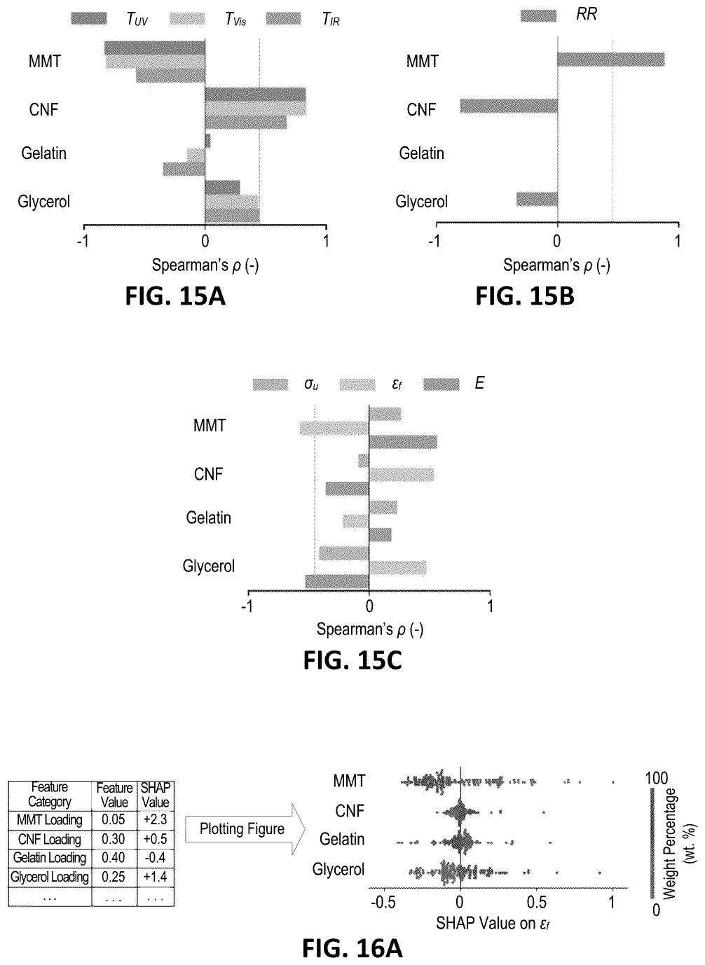

To improve the model's interpretability, multiple data analysis methods were implemented on over 150 data collected during active learning loops. First, Spearman's rank correlation coefficients (abbreviated as Spearman's p) were used to statistically assess the non-linear correlations between composition and property labels. Meanwhile, p value was calculated to evaluate whether a significant correlation existed. A strong correlation can be confirmed if there is a high absolute value of Spearman's p (|Spearman's ρ|) and p value≤10⁻². As shown in FIG. 15A, the CNF loading exhibited positive and strong correlations for the spectral labels (T_{UV}, T_{Vis}, T_{IR}), while the MMT loading exhibited negative and strong correlations, as more micro-sized platelets induced light scattering. As shown in FIG. 15B, a positive and strong correlation for the RR label was found with the MMT loading, which retarded oxygen permeation and thus decreased flammability. As shown in FIG. 15C, the CNF loading was positively correlated with ε_{f} for the mechanical labels.

Shapley Additive explanations (abbreviated as SHAP) was also adopted to further uncover complex composition-property correlations. SHAP is a game theoretic approach to explain the output of any AI/ML model. Basically, SHAP contains a permutation explainer program, and it works by iterating over complete permutations of the features. By continuing to conduct the iterations, the SHAP values are then calculated to approximate the contribution of each component loading to a specific property. A positive SHAP value refers to a positive correlation and vice versa. In the SHAP approach, all composition labels (CNF loading, MMT loading, gelatin loading, and glycerol loading) were fed into the prediction model to obtain the property labels. The prediction process is treated as a game, and the deviation (e.g., between the predicted property label of a specific data point and the average property label from all data points) is treated as the reward. The SHAP value of each composition label on a specific property label can be calculated as:

SHAP value of a composition label=Sum of mariginal reward of a compoisiton label on a specific property label under all possible sequences/Number of total possible sequences.

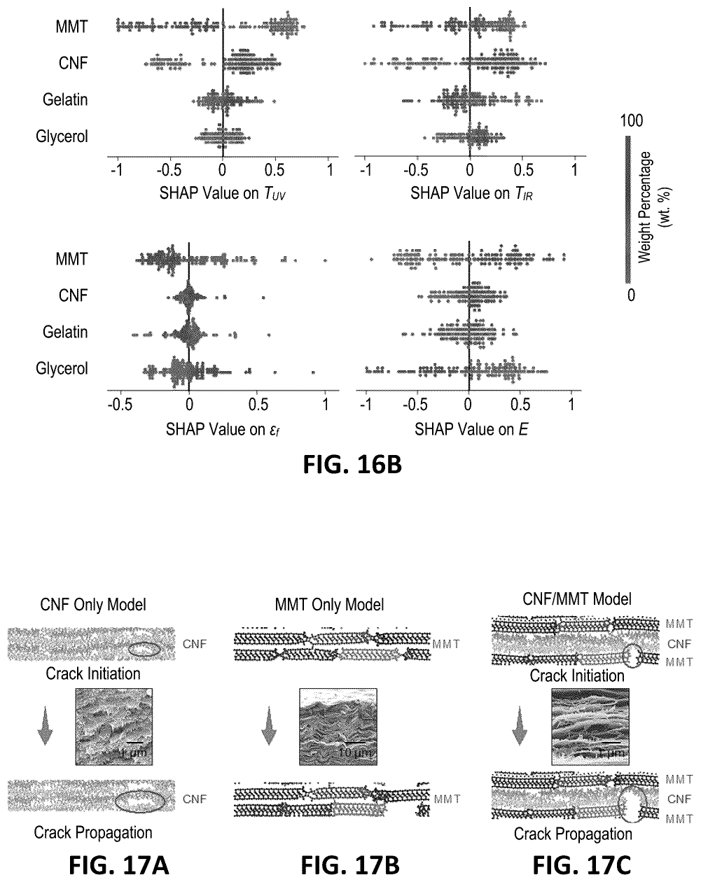

The above process is the interpretation of the prediction model on a specific data point, which is called the local interpretation. To get the global interpretation of the prediction model over all data points, the SHAP values of every composition label was plotted for every data point, as shown in FIG. 16A. A wider range of the SHAP value for a specific feature indicates a higher importance and vice versa. In this study, the SHAP values of MMT, CNF, gelatin, and glycerol loadings were calculated to evaluate their impacts to a specific property label. Taking T_{Vis} as an example, the SHAP values of MMT and CNF loadings fluctuated from −0.9 to +0.4 and from −1.0 to +0.5, respectively, as shown in FIG. 13D, indicating that both components were equally influential yet had the opposite effects. In contrast, the gelatin and glycerol loadings were less significant on T_{Vis}, as their SHAP values were distributed in narrower ranges. Similar SHAP analysis was conducted on RR. As shown in FIG. 13D, the MMT loading had a strong, positive impacts, while the CNF loading had a strong, negative influences. As shown in FIG. 13D, the SHAP values of MMT and CNF loadings were both distributed from −0.6 to +0.8, suggesting that these two components might have synergistic strengthening effects at molecular scale, which was investigated through MD simulations. Additional SHAP analyses on T_{UV}, T_{IR}, ε_{f}, and E are shown in FIG. 16B.

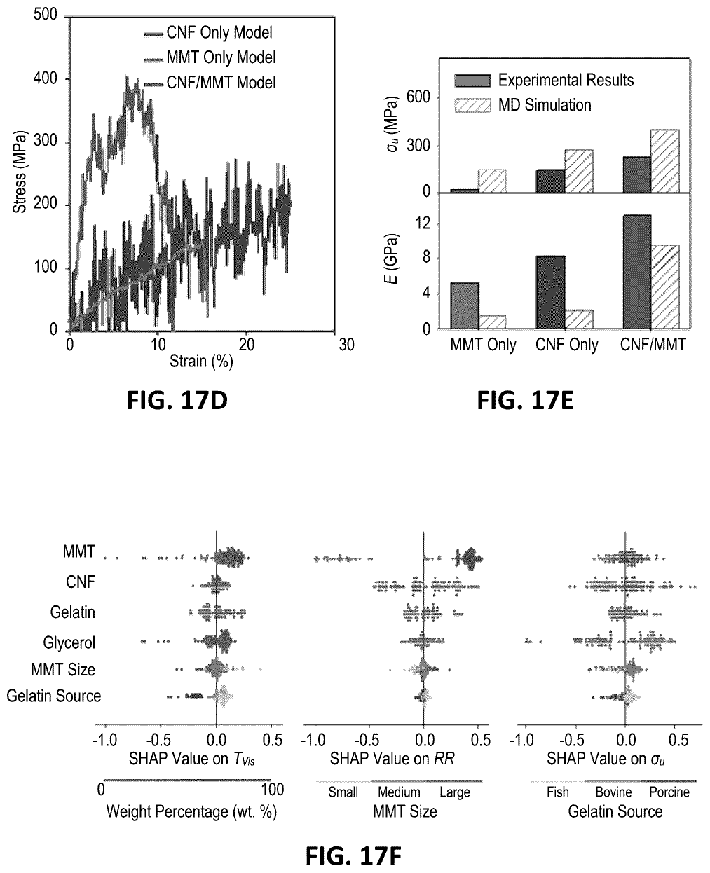

To investigate the strengthening mechanism between CNF chains and MMT nanosheets, MD simulations were performed on three models under tension: CNF only, MMT only, and MMT/CNF models. The construction of these models is further described in METHODS below. The atomic structures of these models are presented in FIG. 17A-17C. As shown in FIG. 17A, the CNF only model exhibited chain sliding behaviors, which led to crack formation/propagation and eventually caused tensile failure. As shown in FIG. 17D, the stress-strain curve of the CNF only model featured a zigzag profile, corresponding to the cascade events of hydrogen-bond formation, breaking, and reformation between neighboring cellulose chains. On the other hand, the MMT only model was more brittle and developed inter-particle fractures upon tension, as shown in FIG. 17B. As shown in FIG. 17D, the stress-strain curve of the MMT only model was quasi-linear and had an abrupt stress drop upon tensile failure.

In the MMT/CNF model, the tensile failure mechanism was distinct from the CNF only and MMT only models. As shown in FIG. 17C, cracks initially developed between neighboring MMT particles upon tension. Through these open cracks, the cellulose chains then underwent localized tensile deformation, further propagating the cracks toward tensile failure of the MMT/CNF model. As the MMT/CNF interfaces exhibited high binding energy, the cracks upon tension propagated only in the perpendicular direction (in the y-direction), and the chain sliding behaviors were largely refrained. Unlike the CNF only and MMT only models, the MMT/CNF model upon tension involved a certain amount of CNF fractures and thus demonstrated a higher tensile strength.

To further demonstrate the close alignment between MD simulation results and experimental validation, three thin-film samples were fabricated: one composed of MMT nanosheets only, one composed of CNFs only, and one made from a 1:1 MMT/CNF mixture, using a vacuum-assisted filtration method. As shown in FIG. 17D-17E, the tensile fracture surfaces of these samples were observed under SEM, which provided evidence in alignment with the MD-simulated results. For example, the MMT only thin film displayed a sharp and clear-cut fracture surface, whereas the CNF only film displayed cross-sectional regions where fibers were pulled out at the points of rupture. In contrast, the MMT/CNF thin film revealed rough, rugged fracture surfaces, featuring multiple MMT/CNF sub-components that had intertwined due to tension. Both MD simulations and experimental results show similar trends in ultimate strengths and Young's moduli (MMT/CNF>CNF only >MMT only). For example, the MMT/CNF model (9.5 GPa) is significantly stiffer than the CNF only (2.1 GPa) and MMT only models (1.4 GPa), which agree well with the experimental results.

Crystalline MMT exhibits an exceptionally high Young's modulus of 178 GPa, which is notably higher than that of most biopolymers. However, natural MMT exhibits a range of Young's moduli, varying from 6 to 63 GPa, due to the presence of defects and weak interlayer interactions. In this study, the MMT-only thin films were fabricated by initially exfoliating natural MMT crystals, a process during which the interfacial ions were dissolved in the solvent (e.g., water). Following the production of MMT nanosheets, they were assembled into a multilayer configuration. Consequently, the self-assembled MMT multilayers exhibited a significant reduction in their Young's moduli, primarily attributing to the presence of defects and the absence of interfacial ions. To simulate the thin-film preparation conditions, the MMT only model was constructed with partial removal of interfacial ions between MMT layers, resulting in a lower Young's modulus of approximately 1.4 GPa. In contrast, the CNF only model contained cellulose chains rich in hydroxyl groups, which facilitated the formation of hydrogen bonds between neighboring CNF units, leading to strong interlayer interactions. In summary, the Young's moduli of self-assembled MMT multilayers could be lower than that of crystalline MMT and comparable to CNF only thin films.

The stiffness of CNF only and MMT only samples is largely dictated by the initial clastic response of the inter-fiber interactions of CNFs and the inter-particle interactions of MMT nanosheets. In contrast, due to the electronegativity of the MMT surface, the polar groups on the CNF chains can be bound tightly to MMT nanosheets, leading to strong interactions at the CNF/MMT interfaces. Such strong CNF/MMT bonding effectively constrains the inter-fiber deformation in CNFs and the inter-particle deformation in MMT nanosheets upon tension. Instead, the elongation of the MMT/CNF model is accommodated by stretching individual CNF fiber and MMT particle, which lead to a stiffness significantly higher than the CNF only and MMT only models. When subjected to tension, the initially curvy cellulose chains are first straightened, and the intrachain hydrogen-bonds (between repeating unit of individual cellulose chains) are gradually broken, thus decreasing the hydrogen-bond energy initially. As the applied tension increases, the elongation of cellulose chains are associated with many breaking and reforming events of interchain hydrogen bonds, which dictates the fluctuation stage of the hydrogen-bond energy. Finally, an abrupt drop of hydrogen-bond energy in the third stage corresponds to the breaking of a large number of hydrogen bonds that results from the crack propagation followed by the final tensile failure of the MMT/CNF model.

Through the combined use of SHAP analyses and MD simulations, a promising solution to the “black box” challenges often associated with AI/ML predictions is provided, thereby enhancing the champion model's interpretability. It can be important to understand the influences of both structural and physical attributes of building blocks on the end-product properties, as well as ensuring the model's prediction accuracy. For instance, using gelatin from various sources (e.g., cold water fish skin, porcine skin, bovine skin) resulted in large changes in the optical properties (e.g., T_{IR}, T_{Vis}, T_{UV}) of all-natural nanocomposites, while subtle variations were observed in the mechanical properties. Furthermore, when the MMT size decreased from 410×410 nm² to 210×210 nm², the ultimate strengths of the fabricated nanocomposites decreased correspondingly.

To account for the structural and physical attributes of building blocks in the prediction model, several approaches were explored, including molecular string representations and MD simulations. Utilizing molecular string representations (e.g., SMILES, SELFIES, or mol2vec) allows for capturing the complex chemical structure of each building block, including bonds, functional groups, chirality, and more. For example, glycerol and gelatin can be denoted using SMILES as “C(C(CO)O)O” and “[H][C@@]1(C[C@@](C)(O)[C@@H](O)[C@H](C)O1)O[C@H]1[C@H](C)[C@@H](O)[C@](C)(O)[C@@H](CC)OC(═O)[C@@H]1C”, respectively. However, significant challenges exist in describing gelatin from various sources and representing structural nanomaterials, such as MMT nanosheets or CNFs. Alternatively, MD simulations can provide valuable insights into the intricate molecular interactions among various building blocks. By incorporating the MD simulation results into the prediction model, the molecular interactions between building blocks and their structural and physical influences can be assessed.

For example, two distinct MMT/CNF models were constructed: one comprising CNF chains at 80% of their original lengths and another with MMT nanosheets at 60% of their original sizes. The stress-strain curves for these two MMT/CNF models were simulated. Both models, with shorter CNF chains and smaller MMT nanosheets, exhibited much reduced mechanical resilience, which aligns well with the experimental evidence. These initial studies highlighted the potential of using MD simulations to incorporate the structural and physical influences of building blocks into the prediction model. However, running MD simulations for the systems that include three or more building blocks at various ratios requires considerable computational resources, which could hinder the model's learning efficiency.

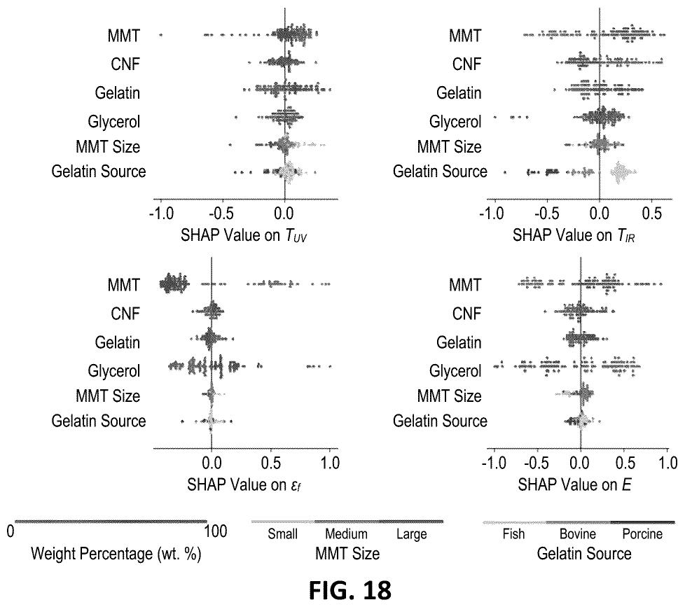

A practical approach was a sensitivity analysis to determine how specific structural and chemical parameters influenced the end property labels. In particular, 24 different MMT/CNF/gelatin/glycerol ratios were chosen to examine the effects of gelatin source and the MMT size on the properties of all-natural nanocomposites. In total, six sets of all-natural nanocomposites, with each set containing 24 variants, were prepared using three different types of gelatin (cold fish skin, porcine skin, bovine skin) and three MMT sizes (large-, medium-, small-sized nanosheets). Subsequently, the optical, fire-resistant, and mechanical properties of 144 all-natural nanocomposites were evaluated and fed into the prediction model. Next, SHAP analyses were used to determine the influences of different gelatin sources and MMT sizes on all nine property labels, as illustrated in FIGS. 17F and 18. The SHAP values suggested that both gelatin source and MMT size have considerable impacts on the optical properties (T_{IR}, T_{Vis}, T_{UV}). In contrast, their influences on the fire-resistant and mechanical properties (RR, σᵤ, ε_{f}, and E) were limited, as reflected by the narrower SHAP values.

The combination of collaborative robotics, SVM classifier, active learning loops, and data augmentation enabled the construction of a high-accuracy prediction model that contained over 140,000 data points. By utilizing the prediction model with the lowest MRE of 17%, the inverse design of all-natural nanocomposites as biodegradable plastic substitutes was successfully demonstrated without the need for tedious optimization cycles. Furthermore, the black box nature of the prediction model was interpreted by conducting multiple data analyses (including Spearman's p and SHAP), and several data scientific insights were generalized. One of the data-driven insights was then validated via MD simulation tools, showing that the high binding energy at the MMT/CNF interfaces led to a distinct tensile failure mechanism and synergistically strengthened the MMT/CNF nanocomposites. In contrast to conventional design methodologies that heavily rely on the one-factor-at-a-time (OFAT) approach, the disclosed approach utilizing collaborative robotics, AI/ML predictions, and MD simulations can automatically pinpoint optimal fabrication recipes for crafting all-natural nanocomposites to meet various property standards.

### METHODS

Materials: Montmorillonite (MMT, BYK Additives Incorporation; Cloisite® Na+), northern bleached softwood kraft (NBSK) pulp (NIST® RM 8495), TEMPO (Sigma-Aldrich, 99%), sodium bromide (NaBr, Sigma-Aldrich, ACS reagent, ≥99.0%), sodium hypochlorite solution (NaClO, Sigma-Aldrich, reagent grade, available chlorine 10-15%), sodium hydroxide (NaOH, Sigma-Aldrich, reagent grade, ≥98%), gelatin (Sigma-Aldrich, from cold-water fish skin), and glycerol (Sigma-Aldrich, ACS reagent, >99.5%) were used as received without further purification. Deionized (DI) water (18.2 M(2) was obtained from a Milli-Q water purification system (Millipore Corp., Bedford, MA, USA) and used as the water source throughout this work.

Preparation of MMT nanosheet dispersion: An MMT nanosheet dispersion was prepared. To obtain medium-sized MMT nanosheets, MMT powders were mixed in DI water at 10 mg mL 1, and the mixture was ultrasonicated for 2 hours and continuously stirred for another 12 hours. Afterward, the mixture was centrifuged at 4,000 revolutions per minute (rpm) for 60 minutes, and the supernatant was then collected as the dispersion of MMT nanosheets with the concentration about 8 mg mL 1. To obtain small-sized MMT nanosheets, the ultrasonication time was extended to 3 hours, and the mixture was centrifuged at 8,000 rpm for 60 minutes. Conversely, for large-sized MMT nanosheets, the ultrasonication time was reduced to 1 hour, and the mixture was centrifuged at a slower speed of 2,500 rpm for 15 minutes.

Preparation of CNF dispersion: A CNF dispersion was prepared. First, 20 g of NBSK pulp was suspended in 1.0 L of DI water, and then (2,2,6,6-Tetramethylpiperidin-1-yl)oxyl (TEMPO) (2×10⁻³ mole) and NaBr (0.02 mole) were added into the pulp. The TEMPO-mediated oxidation was initiated by adding 0.2 mole of NaClO, and the oxidation process was maintained under continuous stirring for 5-6 hours, during which the pH was controlled at 10.0 by adding NaOH solution (3.0 M). The TEMPO-oxidized pulp was repeatedly washed with DI water until the pH returned back to 7.0. Afterward, the pulp was disassembled in a microfluidizer processor (Microfluidics M-110EH), and the concentration of CNF dispersion was about 10 mg mL⁻¹.

Preparation of gelatin solution: 8.0 g of gelatin was dissolved in 1.0 L of DI water followed by continuous stirring for 48 hours, and the concentration of gelatin solution was 8.0 mg mL⁻¹.

Preparation of glycerol solution: 8.4 g of glycerol was dissolved in 1.0 L of DI water followed by continuous stirring for 12 hours, and the concentration of glycerol solution was 8.4 mg mL⁻¹.

Fabrication of all-natural nanocomposite films via an automated pipetting robot: An automated pipetting robot (Opentrons OT-2) was operated to prepare different mixtures with varying MMT/CNF/gelatin/glycerol ratios. For each mixture, the dispersions/solutions of MMT nanosheets, CNFs, gelatin, and glycerol were mixed at different volumes. Afterward, the robot-prepared mixtures were vortexed at 3,000 rpm for 30 seconds and placed in a vacuum desiccator to remove air bubbles. Then, the mixtures were cast into a flat, polystyrene-based container at 40° C. and air dried for 48 hours.

Identification of A-grade nanocomposites: Each nanocomposite film was subject to detachment and flatness testing after it dried. Regarding detachability, except for samples that can be clearly labeled as detachable or non-detachable, mechanical delamination tests were conducted to measure the binding energies of nanocomposite films on hydrophobic polystyrene substrates. All the detachable samples exhibited binding energies of <0.4 J cm⁻², while the undetachable ones were with binding energies >0.6 J cm⁻². Thus, the threshold binding energy was set to be 0.5 J cm⁻² to classify the detachability of nanocomposite films. Regarding flatness, except for samples that can be clearly labeled as flat or curved, a high-speed laser scanning confocal microscope was employed to characterize the roughness of nanocomposite films. The nanocomposite films considered “flat” exhibited height differences of <200 μm. Meanwhile, those considered “curved” typically exhibited height differences of >500 μm. Once the detachment and flatness tests were finished, only the detachable and flat samples were identified as A-grade nanocomposites.

Determination of SVM classifier accuracy: After constructing the SVM classifier, its prediction accuracy was examined using a set of testing data points. A total of 35 MMT/CNF/gelatin/glycerol ratios were randomly selected, and 35 nanocomposite films were fabricated according to the established procedure. Detachment and flatness tests were conducted to categorize these nanocomposite films into different grades. Subsequently, the MMT/CNF/gelatin/glycerol ratios (e.g., composition labels) were input into the SVM classifier to obtain the predicted grades, which were then compared with the experimental results. In this study, the SVM classifier accurately predicted the grades for 33 out of the 35 nanocomposite films, resulting in a prediction accuracy of 94.3%.

Film thickness characterization: The thickness of each all-natural nanocomposite was initially determined using a digital micrometer. For each strip sample used in the mechanical test, the nanocomposite thickness was gauged at three separate points, and the average thickness value was derived. Furthermore, the thickness of the all-natural composites was verified using a field emission scanning electron microscope (FESEM, Tecan XEIA) operating at 15.0 kV. Cross-sectional SEM images were taken, followed by thickness measurements to validate the earlier readings.

Transmittance spectrum characterization: The transmittance spectra of all-natural composites were measured with a UV-vis Spectrometer from 250-1100 nm (UV-3600 Plus, Perkin-Elmer, USA) equipped with an integrating sphere. The transmittance values at 365, 550, 950 nm were extracted as the “spectral” labels (T_{UV}, T_{Vis}, and T_{IR}), respectively.

Fire resistance characterization: The fire resistances of the all-natural nanocomposites were assessed using a horizontal combustibility testing method, modified from the standard test method (ASTM D6413). The all-natural nanocomposites were cut into 1 cm×1 cm squares, and then they were exposed to the flame of an ethanol burner for 30 seconds (with a flame temperature ranging from 600-850° C.). The fire resistance of the all-natural nanocomposites was quantified in terms of RR. Three replicates were conducted, and the average RR values were recorded as the fire labels.

Mechanical property characterization: The stress-strain curves of the all-natural composites were determined using a mechanical testing machine (Instron 68SC-05) fitted with a 500-N load cell. After calibrating the load cell, the all-natural nanocomposites were cut into 3 cm×1 cm stripes and subject to a tensile test at an extension rate of 0.02 mm s⁻¹. The tensile tests started with an initial fixture gap of 2 cm. Three replicates were conducted for each nanocomposite. Materials characterization: The surface functional groups of all-natural nanocomposites were characterized using Fourier transform IR spectroscopy (FT-IR, Thermo Nicolet NEXUS 670). Biocompatibility tests of all-natural nanocomposites: The cytotoxic effects of all-natural nanocomposites on the cultured cells (e.g., L929 cells) were determined in compliance with ISO 10993 (ISO 10993-1:2018, published October 2018 and entitled “Biological evaluation of medical devices, Part 1: Evaluation and testing within a risk management process,” which is incorporated by reference herein). Six all-natural nanocomposites with different MMT/CNF/gelatin/glycerol ratios were incubated with Dulbecco's Modified Eagle Medium (DMEM) (Gibco, UK) supplemented with fetal bovine serum (FBS) (Biological Industries, Beit Hacmek, Israel) at 37° C. for 24 hours, and the media were then extracted for cell culture. L929 cells were then seeded in 96-well cell culture plates at the density of 1×10⁴ cells per well and incubated in a standard cell incubation environment with 5% CO₂. After 24 hours of cell culture, the culture media were removed and replaced with the extracts of all-natural nanocomposites followed by additional 24-hour incubation. After 24 hours, the culture media were withdrawn, and 3-(4,5-dimethylthiazol-2-yl)-2,5-diphenyltetrazolium bromide (MTT) solution was added to each well. Then, the cell culture plate was incubated for 2 hours at 37° C. After the MTT solution was discarded, 200 mL of dimethyl sulfoxide was added to dissolve the formazan crystals. The optical density (O.D.) of the formazan solution was read by an enzyme-linked immunosorbent assay (ELISA) plate reader at 570 nm with a reference wavelength of 650 nm.

The cytotoxicity of all-natural nanocomposites was evaluated by a cytotoxicity detection kit (Roche, Mannheim, Germany). First, the L929 cells were incubated with the all-natural nanocomposite extracts at 37° C. for 24 hours, and the medium (100 μL) was collected and incubated with the reaction mixture from the kit following the manufacturer's instructions. LDH content was assessed by enzyme-linked immunosorbent assay (ELISA) and read at an absorbance of 490 nm in a plate reader with a reference wavelength of 630 nm. To further confirm the cytotoxicity of all-natural nanocomposites, a fluorescence-based live/dead assay (LIVE/DEAD kit, Life, USA) was performed. After the L929 cells were cultured with the extracts for 24 hours, calcein was mixed with ethidium homodimer-1, and the dye (100 μL) was mixed with the retained medium (100 μL), which was added to each well and incubated at 37° C. for 15 minutes. After the incubation, an inverted microscope (Leica DMi8, Germany) was used to capture the images of live (green) and dead (red) cells. Fluorescence with excitation wavelengths of 488 nm and 561 nm was used to visualize the green (515 nm) and red (635 nm) fluorescence signals emitted by calcein and ethidium homodimer-1, respectively. ImageJ software was employed to calculate the proportion of live and dead cell areas. The relative percentages of fluorescence intensity were also determined.

Molecular dynamics (MD) simulations: The full atomistic simulations utilized the ReaxFF potential within the Large-scale Atomic/Molecular Massively Parallel Simulator (LAMMPS) simulation package. The ReaxFF potential is widely used to describe chemical bonds and weak interactions of cellulose chains and MMT nanosheets. The MD model of the MMT/CNF nanocomposite was configured as a multilayered microstructure having alternating CNF chains and MMT nanosheets, similar to the SEM observations. The length of the cellulose chains was set to 104 Å, and the scale of the MMT nanosheets was randomly set between 30-60 Å, corresponding to the length scale ratio in the experiments (LcNF:LMMT=1:2). The cellulose chains and MMT nanosheets were passivated by polar hydrogens or —OH groups. The entire system was equilibrated under the isothermal-isobaric ensemble (i.e., NPT ensemble) at 300 K and 0 atm, using the Nose-Hoover thermostat and barostat. Then, the micro-canonical ensemble was applied in the stretching process. The timestep was set as 0.5 femtosecond, and the periodic boundary conditions were applied in all directions (x, y, and z) for all models. To better understand intermolecular interactions, both cellulose chains and MMT nanosheets were randomly arranged in alignment in the periodical box. All calculations were relaxed using the conjugate gradient (CG) algorithm to minimize the total energy of the system until the total atomic forces were converged to less than 10⁻⁹ CV Å⁻¹.

### CONCLUSION

Any of the features illustrated or described herein, for example, with respect to FIGS. 1A-18, can be combined with any other feature illustrated or described herein, for example, with respect to FIGS. 1A-18 to provide systems, devices, structures, materials, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(A) fabricating, via one or more robotic systems, a plurality of candidate polymer composites, each candidate polymer composite comprising a mixture of at least two natural materials, each natural material being one of a naturally-occurring polysaccharide, a naturally-occurring protein, a naturally-occurring mineral, and a naturally-occurring alcohol;
(B) grading each of the candidate polymer composites in the fabricated plurality with respect to one or more predetermined criteria;
(C) training a classifier based at least in part on the grading;
(D) selecting, using the trained classifier, a reduced design space for mixture recipes of subsequent training polymer composites;
(E) determining mixture recipes within the reduced design space for a plurality of training polymer composites, each training polymer composite comprising a mixture of the at least two natural materials;
(F) fabricating, via the one or more robotic systems, the plurality of training polymer composites according to the determined mixture recipes;
(G) generating a data set based on measurements of one or more physical characteristics of the plurality of training polymer composites, each measurement comprising an actual data point within the data set;
(H) augmenting the data set with a plurality of virtual data points;
(I) training one or more artificial neural networks based at least in part on the augmented data set;
(J) determining, using the one or more artificial neural networks, mixture recipes within the reduced design space for a different plurality of training polymer composites;
(K) repeating (F)-(I) at least once; and
(L) predicting, using the one or more artificial neural networks, a mixture recipe or one or more physical characteristics for a desired polymer composite.

2. The method of claim 1, wherein the predicting of (L) comprises:
receiving a proposed mixture recipe; and
providing, using the one or more artificial neural networks, an estimate of the one or more physical characteristics for the desired polymer composite with the proposed mixture recipe.

3. The method of claim 2, further comprising:
fabricating, via the one or more robotic systems, the desired polymer composite according to the proposed recipe.

4. The method of claim 1, wherein the predicting of (L) comprises:
receiving proposed one or more physical characteristics; and
providing, using the one or more artificial neural networks, the mixture recipe for the desired polymer composite having the proposed one or more physical characteristics.

5. The method of claim 4, further comprising:
fabricating, via the one or more robotic systems, the desired polymer composite according to the provided mixture recipe.

6. The method of claim 1, further comprising:
characterizing, using the one or more artificial neural networks, an influence of at least one of the natural materials on the measured one or more physical characteristics.

7. The method of claim 6, wherein the characterizing comprises Spearman's p or Shapley Additive Explanations.

8. The method of claim 1, further comprising, after (K) and prior to (L), selecting one of the one or more artificial neural networks for use in the predicting of (L), based at least in part on a calculation of mean relative error for each artificial neural network.

9. The method of claim 1, wherein the one or more robotic systems comprises a pipetting robot.

10. The method of claim 1, wherein:
the naturally-occurring polysaccharide comprises cellulose, chitin, chitosan, starch, glycogen, agar, alginate, pectin, gum arabic, and/or hyaluronic acid;
the naturally-occurring mineral comprises montmorillonite;
the naturally-occurring protein comprises gelatin;
the naturally-occurring alcohol comprises glycerol; or
any combination of the above.

11. The method of claim 1, wherein the one or more predetermined criteria of (B) comprises flatness of the candidate polymer composite and/or detachability of the candidate polymer composite from a substrate.

12. The method of claim 1, wherein a ratio of virtual data points to actual data points in the augmented data set is at least 1000:1.

13. The method of claim 1, wherein the one or more physical characteristics of the plurality of training polymer composites comprises one or more optical properties, fire resistance, one or more mechanical properties, one or more shape parameters, cost analysis, and/or life cycle analysis.

14. The method of claim 1, wherein, in (E), the mixture recipes within the reduced design space are randomly determined.

15. The method of claim 1, wherein the classifier comprises a support vector machine classifier.

16. A system comprising:
one or more robotic systems constructed to fabricate polymer composites, each polymer composite comprising a mixture of at least two natural materials, each natural material being one of a naturally-occurring polysaccharide, a naturally-occurring protein, a naturally-occurring mineral, and a naturally-occurring alcohol; and
a machine learning system in communication with the one or more robotic systems, the machine learning system comprising one or more processors and one or more non-transitory computer-readable storage media storing computer-readable instructions that, when executed by the one or more processors, cause the one or more processors to perform functions of one or more constituent modules comprising:
(i) a screening module configured to:
train a classifier based at least in part on grading of candidate polymer composites with respect to one or more predetermined criteria; and
select, using the trained classifier, a reduced design space for mixture recipes of subsequent training polymer composites;
(ii) an input/output module configured to:
instruct the one or more robotic systems to fabricate training polymer composites according to respective mixture recipes within the reduced design space; and
receive measurements of one or more physical characteristics of fabricated polymer composites, each measurement forming an actual data point in a data set;
(iii) a data augmentation module configured to augment the data set with a plurality of virtual data points;
(iv) a training module configured to:
train one or more artificial neural networks of the machine learning system based at least in part on the augmented data set; and
determine, using the one or more artificial neural networks, the respective mixture recipes within the reduced design space for the training polymer composites to be fabricated by the one or more robotic systems; and
(v) a prediction module configured to predict, using the one or more artificial neural networks, a mixture recipe or one or more physical characteristics for a desired polymer composite.

17. The system of claim 16, wherein the classifier comprises a support vector machine classifier.

18. The system of claim 16, wherein the one or more robotic systems comprises a pipetting robot.

19. The system of claim 16, further comprising:
one or more automated testing systems constructed to measure the one or more physical characteristics of the fabricated polymer composites,
wherein the one or more physical characteristics comprising one or more optical properties, fire resistance, one or more mechanical properties, and/or one or more shape parameters of the fabricated polymer composites.

20. A non-transitory computer-readable storage medium storing computer-readable instructions that, when executed by one or more processors, cause the one or more processors to:
determine mixture recipes for a plurality of polymer composites, each polymer composite comprising a different mixture of at least two natural materials, each natural material being one of a naturally-occurring polysaccharide, a naturally-occurring protein, a naturally-occurring mineral, and a naturally-occurring alcohol;
instruct fabrication of the plurality of polymer composites according to the determined mixture recipes;
receive a data set comprising measurements of one or more physical characteristics of the plurality of polymer composites, each measurement comprising an actual data point within the data set;
augment the data set with a plurality of virtual data points;
train one or more artificial neural networks based at least in part on the augmented data set; and
predict, using the one or more artificial neural networks, a mixture recipe or one or more physical characteristics for a desired polymer composite.
